(19) United States
(12) Patent Application Publication
(10) Pub. No.: US 2017/0002176 A1
(43) Pub. Date: Jan. 5, 2017

(54) POLYMERIZABLE COMPOSITION FOR OPTICAL MATERIALS, OPTICAL MATERIAL AND PLASTIC LENS OBTAINED FROM COMPOSITION

(71) Applicant: MITSUI CHEMICALS, INC., Tokyo (JP)

(72) Inventor: Shinichiro KADOWAKI, Omuta-shi (JP)

(73) Assignee: MITSUI CHEMICALS, INC., Tokyo (JP)

(21) Appl. No.: 15/113,146

(22) PCT Filed: Feb. 2, 2015
(86) PCT No.: PCT/JP2015/052874

§ 371 Date: Jul. 21, 2016

(30) Foreign Application Priority Data
Feb. 3, 2014 (JP) 2014-018928

(51) Int. Cl. C08K 5/1545; C08G 18/48; C08G 18/32; G02B 1/04; C08G 18/38; C08G 18/76; C08G 18/42; C08G 18/75; C08G 18/66

(52) U.S. Cl. CPC C08K 5/1545; C08G 18/757; C08G 18/487; C08G 18/3206; C08G 18/6677; C08G 18/3876; C08G 18/6666; C08G 18/758; C08G 18/7642; C08G 18/4216; C08G 18/6633; G02B 1/041

(57) ABSTRACT

A polymerizable composition for optical materials of the present invention includes a polyisocyanate compound (A), a polyol compound (B) represented by the following General Formula (1) having a number average molecular weight of 100 or more, a di- or higher functional active hydrogen compound (C) (here, the compound (B) is excluded), and a photochromic compound (D).

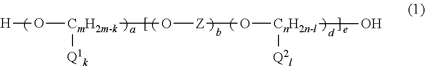

### TECHNICAL FIELD

The present invention relates to a polymerizable composition for optical materials including a photochromic compound, and an optical material and a plastic lens obtained from the composition.

### BACKGROUND ART

Since plastic lenses are light and not easily cracked in comparison to inorganic lenses, plastic lenses have been rapidly distributed as optical elements such as spectacle lenses, camera lenses. In recent years, development of plastic lenses having photochromic property has been progressing.

In addition, among these, a lens obtained from poly(thio)urethane has attracted attention from the viewpoint that the lens has a high refractive index and physical properties thereof such as strength is excellent.

Patent Document 1 describes a lens formed of a composition including a predetermined photochromic compound and a di(meth)acrylate compound. In paragraph “0009”, it is described that in a case where a urethane resin or a thiourethane resin having a high refractive index is used, isocyanate which is a resin raw material in a monomer state reacts with a photochromic compound, and due to this, photochromic property is completely eliminated.

Patent Document 2 discloses a lens obtained by providing a coating layer formed of a composition including a photochromic compound having a chromene skeleton and a phenol compound on a surface of a thiourethane-based plastic lens.

Patent Document 3 discloses a photochromic lens having a lens substrate formed of a thiourethane resin and a photochromic film formed by applying a solution including a photochromic compound and a radically polymerizable monomer to the substrate. Patent Document 4 discloses a compound having photochromic properties.

Patent Document 5 discloses a polymerizable composition for optical materials including at least one kind of isocyanate compounds selected from aliphatic isocyanate compounds and alicyclic isocyanate compounds, a di- or higher functional active hydrogen compound, and a photochromic compound.

### RELATED DOCUMENT

### Patent Document

[Patent Document 1] Japanese Unexamined Patent Publication No. 8-272036

[Patent Document 2] Japanese Unexamined Patent Publication No. 2005-23238

[Patent Document 3] Japanese Unexamined Patent Publication No. 2008-30439

[Patent Document 4] Japanese Unexamined Patent Publication No. 2011-144181

[Patent Document 5] Pamphlet of International Publication No. WO2014/002844

[Patent Document 6] U.S. Pat. No. 6506538

[Patent Document 7] Japanese Unexamined Patent Publication No. 2005-305306

[Patent Document 8] WO2005/087829

[Patent Document 9] WO2006/109765

[Patent Document 10] WO2007/020817 [Patent Document 11] WO2007/020818 [Patent Document 12] WO2014/002844

### SUMMARY OF THE INVENTION

Even in a case where an optical material having photochromic property formed of poly (thio) urethane is obtained, there is a problem that the photochromic compound reacts with isocyanate which is a monomer, and due to this, photochromic property is not exhibited at all, as described in paragraph “0009” of Patent Document 1.

In addition, Patent Document 5 describes that, according to a poly(thio)urethane-based composition for optical materials obtained by using a specific polyisocyanate compound, photochromic property is imparted to the obtained optical material. However, there is room for further improvement in applications with the main purpose of light shielding, such as sunglasses, from the viewpoint of the amount of changes in light transmittance.

The present invention can be described as follows.

[1] A polymerizable composition for optical materials, comprising:

a polyisocyanate compound (A),

a polyol compound (B) represented by the following General Formula (1) having a number average molecular weight of 100 or more,

a di- or higher functional active hydrogen compound (C) in which the compound (B) is excluded and

a photochromic compound (D),

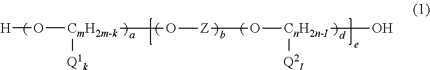

wherein, in Formula (1), m represents a numerical value of 1 to 20, k represents 0 to 2m, n represents a numerical value of 1 to 20, 1 represents 0 to 2n, a represents a numerical value of 0 or more, b represents a numerical value of 0 or more, d represents a numerical value of 0 or more, and e represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and Z represents a divalent organic group having 1 to 30 carbon atoms which optionally include an aromatic group, and a plurality of Z's may be the same as or different from each other.

[2] The polymerizable composition for optical materials according to [1],

wherein the polyisocyanate compound (A) is at least one kind selected from the group consisting of hexamethylene diisocyanate, pentamethylene diisocyanate, xylylene diisocyanate, isophorone diisocyanate, bis(isocyanatomethyl) cyclohexane, dicyclohexylmethane diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, and diphenylmethane diisocyanate.

[3] The polymerizable composition for optical materials according to [1] or [2],

wherein the polyol compound (B) is at least one kind selected from compounds which have a number average molecular weight of 100 or more and which are represented by the following General Formulas (I) to (IV),

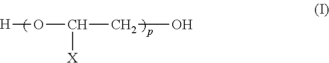

wherein, in Formula (I), p represents a numerical value of 4 to 100, X represents a hydrogen atom or a methyl group, and a plurality of X's may be the same as or different from each other,

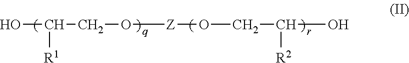

wherein, in Formula (II), q and r may be the same as or different from each other, each of q and r represents a numerical value of 1 or more, and the sum of q and r represents a numerical value of 2 to 100; R¹ and R² may be the same as or different from each other, each of R¹ and R² represents a hydrogen atom or a methyl group, and a plurality of R¹'s or R²'s may be the same as or different from each other; and Z represents a substituted or unsubstituted divalent aromatic group or a divalent aliphatic group which optionally include a substituted or unsubstituted aromatic group having 1 to 20 carbon atoms,

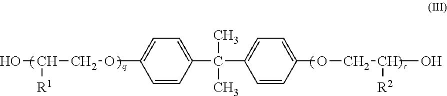

wherein, in Formula (III), q and r may be the same as or different from each other, each of q and r represents a numerical value of 1 or more, and the sum of q and r represents a numerical value of 2 to 100; and R¹ and R² may be the same as or different from each other, each of R¹ and R² represents a hydrogen atom or a methyl group, and a plurality of R¹'s or R²'s may be the same as or different from each other,

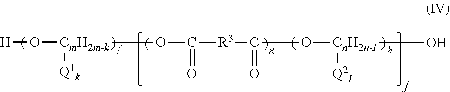

wherein, in Formula (IV), m represents a numerical value of 1 to 20, k represents 0 to 2m, n represents a numerical value of 1 to 20, 1 represents 0 to 2n, f represents a numerical value of 0 or more, g represents a numerical value of 1 or more, h represents a numerical value of 1 or more, and j represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and R³ represents a linear or branched alkylene group having 1 to 20 carbon atoms or a phenylene group which optionally have a linear or branched alkyl group having 1 to 10 carbon atoms as a substituent, and the plurality of R³'s may be the same as or different from each other.

[4] The polymerizable composition for optical materials according to [3],

wherein the polyol compound (B) is the compound represented by General Formula (I), (III), or (IV).

[5] The polymerizable composition for optical materials according to [3] or [4],

wherein the compound represented by General Formula (I) is polyethylene glycol or polypropylene glycol.

[6] The polymerizable composition for optical materials according to any one of [3] to [5],

wherein the number average molecular weight of the compound represented by General Formula (I) is 200 to 4000.

[7] The polymerizable composition for optical materials according to any one of [3] to [5],

wherein the number average molecular weight of the compound represented by General Formula (I) is 300 to 3000.

[8] The polymerizable composition for optical materials according to [3] or [4],

wherein the number average molecular weight of the compound represented by General Formula (II) is 400 to 2000.

[9] The polymerizable composition for optical materials according to [3] or [4],

wherein the number average molecular weight of the compound represented by General Formula (III) is 400 to 2000.

[10] The polymerizable composition for optical materials according to [3] or [4],

wherein the number average molecular weight of the compound represented by General Formula (IV) is 600 to 3000.

[11] The polymerizable composition for optical materials according to any one of [1] to [10],

wherein the active hydrogen compound (C) is at least one kind selected from the group consisting of polyol compounds, polythiol compounds, and thiol compounds having a hydroxy group.

[12] The polymerizable composition for optical materials according to any one of [1] to [11],

wherein the active hydrogen compound (C) is a tri- or higher functional active hydrogen compound.

[13] The polymerizable composition for optical materials according to any one of [1] to [12],

wherein the active hydrogen compound (C) is at least one kind selected from the group consisting of glycerin, pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, 1,1,3,3-tetrakis(mercaptomethylthio) propane, and trimethylolpropane tris(3-mercaptopropionate).

[14] The polymerizable composition for optical materials according to any one of [1] to [13],

wherein the photochromic compound (D) is represented by the following General Formula (5),

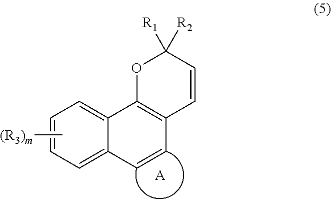

wherein in the formula, R₁ and R₂ may be identical or different, and independently represent

a hydrogen atom;

a linear or branched alkyl group having 1 to 12 carbon atoms;

a cycloalkyl group having 3 to 12 carbon atoms;

a substituted or unsubstituted aryl group having 6 to 24 carbon atoms or a substituted or unsubstituted heteroaryl group having 4 to 24 carbon atoms in which these substituted groups , as a substituent, include at least one substituent selected from a halogen atom, a hydroxyl group, a linear or branched alkyl group having 1 to 12 carbon atoms, a linear or branched alkoxy group having 1 to 12 carbon atoms, a linear or branched haloalkyl group having 1 to 12 carbon atoms that is substituted by at least one halogen atom, a linear or branched haloalkoxy group having 1 to 12 carbon atoms that is substituted by at least one halogen atom, a phenoxy group or naphthoxy group substituted by at least one linear or branched alkyl group or alkoxy group having 1 to 12 carbon atoms, a linear or branched alkenyl group having 2 to 12 carbon atoms, a —NH₂ group, a —NHR group, a —N(R)₂ group in which R represents a linear or branched alkyl group having 1 to 6 carbon atoms, in which in a case that two Rs are present, the two Rs may be identical or different, a methacryloyl group and an acryloyl group; or
an aralkyl or heteroaralkyl group that a linear or branched alkyl group having 1 to 4 carbon atoms is substituted by the aryl group or the heteroaryl group,

R₃ may be identical or different, and independently represent

a halogen atom;

a linear or branched alkyl group having 1 to 12 carbon atoms;

a cycloalkyl group having 3 to 12 carbon atoms;

a linear or branched alkoxy group having 1 to 12 carbon atoms;

a linear or branched haloalkyl group having 1 to 12 carbon atoms that is substituted by at least one halogen atom, a halocycloalkyl group having 3 to 12 carbon atoms that is substituted by at least one halogen atom, a linear or branched haloalkoxy group having 1 to 12 carbon atoms that is substituted by at least one halogen atom;

a substituted or unsubstituted aryl group having 6 to 24 carbon atoms or a substituted or unsubstituted heteroaryl group having 4 to 24 carbon atoms in which these substituted groups, as a substituent, include at least one substituent selected from a halogen atom, a hydroxyl group, a linear or branched alkyl group having 1 to 12 carbon atoms, a linear or branched alkoxy group having 1 to 12 carbon atoms, a linear or branched haloalkyl group having 1 to 12 carbon atoms that is substituted by at least one halogen atom, a linear or branched haloalkoxy group having 1 to 12 carbon atoms that is substituted by at least one halogen atom, a phenoxy group or naphthoxy group substituted by at least one linear or branched alkyl group or alkoxy group having 1 to 12 carbon atoms, a linear or branched alkenyl group having 2 to 12 carbon atoms, and an amino group;

an aralkyl or heteroaralkyl group that a linear or branched alkyl group having 1 to 4 carbon atoms is substituted by the aryl group or heteroaryl group;

a substituted or unsubstituted phenoxy group or naphthoxy group, in which these substituted groups, as a substituent, include at least one substituent selected from a linear or branched alkyl group or alkoxy group having 1 to 6 carbon atoms;

—NH₂, —NHR, —CONH₂, or —CONHR in which R represents a linear or branched alkyl group having 1 to 6 carbon atoms; or

—OCOR₈ or —COOR_{S} in which R₈ represents a linear or branched alkyl group having 1 to 6 carbon atoms, a cycloalkyl group having 3 to 6 carbon atoms, or a phenyl group substituted by at least one substituents of the substituted aryl and the substituted heteroaryl group of R₁ or R₂, or an unsubstituted phenyl group;

m is an integer of 0 to 4;

A represents an annelated ring represented by the following Formula (A₂) or (A₄), and

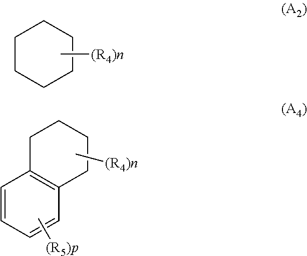

wherein, in these annelated rings,

the dotted lines represent a chemical bond between a carbon C₅ and a carbon C₆ in a naphthopyran ring of a formula (5);
an α bond in the annelated ring (A4) can be bonded with the carbon C₅ or the carbon C₆ in the naphthopyran ring of Formula (5);

R₄ is identical or different, and independently represents OH, a linear or branched alkyl group or alkoxy group having 1 to 6 carbon atoms; two R₄s form carbonyl (CO);

R₅ represents halogen atom;

a linear or branched alkyl group having 1 to 12 carbon atoms;

a linear or branched haloalkyl group having 1 to 6 carbon atoms that is substituted by at least one halogen atom;

a cycloalkyl group having 3 to 12 carbon atoms;

a linear or branched alkoxy group having 1 to 6 carbon atoms;

a substituted or unsubstituted phenyl or benzyl group in which these substituted groups include at least one substituents described in the definition of the R₁ and R₂ groups as a substituent in a case that R₁ and R₂ in Formula (5) independently correspond to an aryl or heteroaryl group;

—NH₂ or —NHR in which R represents a linear or branched alkyl group having 1 to 6 carbon atoms;

a substituted or unsubstituted phenoxy group or naphthoxy group in which these substituted groups, as a substituent, include at least one substituent selected from a linear or branched alkyl group or alkoxy group having 1 to 6 carbon atoms; or

a —COR₉, —COOR_{S}, or —CONHR₉ group in which R₉ represents a linear or branched alkyl group having 1 to 6 carbon atoms, a cycloalkyl group having 3 to 6 carbon atoms, or a substituted or unsubstituted phenyl or benzyl group in which these substituted groups include at least one substituents described in the definition of the R₁ and R₂ groups as a substituent in a case that R₁ and R₂ in Formula (5) independently correspond to an aryl or heteroaryl group,

in a case in which A represents (A₄), n is an integer of 0 to 2, p is an integer of 0 to 4, and in a case in which A represents (A₂), n is an integer of 0 to 2.

[15] The polymerizable composition for optical materials according to any one of [1] to [14],

wherein the functional group equivalent ratio (B/A) of the polyol compound (B) to the polyisocyanate compound (A) is 0.02 to 0.6, and the functional group equivalent ratio (C/A) of the active hydrogen compound (C) to the polyisocyanate compound (A) is 0.4 to 0.98.

[16] A molded product comprised of a cured product of the polymerizable composition for optical materials according to any one of [1] to [15].

[17] An optical material comprised of the molded product according to [16].

[18] A plastic lens comprised of the molded product according to [16].

[19] A process for producing a plastic lens, comprising:

a step of preparing a polymerizable composition for optical materials by mixing a polyisocyanate compound (A), a polyol compound (B) represented by the following General Formula (1) having a number average molecular weight of 100 or more, a di- or higher functional active hydrogen compound (C) in which the compound (B) is excluded, and a photochromic compound (D) and

a step of forming a lens substrate by cast-polymerizing the polymerizable composition for optical materials in a mold,

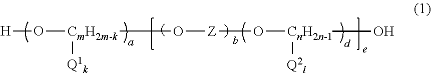

wherein, in Formula (1), m represents a numerical value of 1 to 20, k represents 0 to 2m, n represents a numerical value of 1 to 20, 1 represents 0 to 2n, a represents a numerical value of 0 or more, b represents a numerical value of 0 or more, d represents a numerical value of 0 or more, and e represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and Z represents a divalent organic group having 1 to 30 carbon atoms which optionally include an aromatic group, and a plurality of Z's may be the same as or different from each other.

According to the polymerizable composition for optical materials of the present invention, it is possible to obtain a polyurethane-based optical material or a polythiourethane-based optical material including a photochromic compound, which exhibits excellent photochromic property without causing deterioration in property of the photochromic compound, and is also excellent in physical properties such as mechanical strength.

### DESCRIPTION OF EMBODIMENTS

The polymerizable composition for optical materials of the present invention will be described based on the following embodiment.

The polymerizable composition for optical materials of the present embodiment includes

a polyisocyanate compound (A),

a polyol compound (B) represented by the following General Formula (1) having a number average molecular weight of 100 or more,

a di- or higher functional active hydrogen compound (C) (here, the compound (B) is excluded), and

a photochromic compound (D).

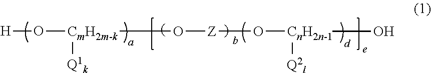

In Formula (1), m represents a numerical value of 1 to 20, k represents 0 to 2m, n represents a numerical value of 1 to 20, 1 represents 0 to 2n, a represents a numerical value of 0 or more, b represents a numerical value of 0 or more, d represents a numerical value of 0 or more, and e represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and Z represents a divalent organic group having 1 to 30 carbon atoms which optionally include an aromatic group, and a plurality of Z's may be the same as or different from each other.

It is considered that the polymerizable composition for optical materials of the present embodiment effectively suppresses the failure of an isomerization reaction of the photochromic compound (D) in the polymer matrix of the composition by including the compounds (A) to (C) in the configuration thereof. That is, it is thought that, by adding the compound (B) which is an essential component of the present invention to a resin in the related art, used in lenses for spectacles or the like formed of the compounds (A) and (C), an appropriate space where an isomerization reaction of the photochromic compound is likely to occur is formed in the matrix molecular chain, and as a result, good photochromic property is achieved. In addition, with this configuration, high photochromic property can be exhibited, and excellent mechanical properties which are the features of a poly(thio)urethane-based resin can be exhibited. That is, the present invention can provide an optical material which is excellent in terms of balance of these properties.

Hereinafter, each component will be described.

[Polyisocyanate Compound (A)]

Examples of the polyisocyanate compound (A) include aliphatic polyisocyanate compounds such as hexamethylene diisocyanate, pentamethylene diisocyanate, 2,2,4-trimethyl hexanediisocyanate, 2,4,4-trimethyl hexamethylene diisocyanate, lysine diisocyanatomethyl ester, lysine triisocyanate, m-xylylene diisocyanate, o-xylylene diisocyanate, p-xylylene diisocyanate, xylylene diisocyanate, α, α, α′, α′-tetramethylxylylene diisocyanate, bis(isocyanatomethyl) naphthalene, mesitylylene triisocyanate, bis(isocyanatomethyl) sulfide, bis(isocyanatoethyl) sulfide, bis(isocyanatomethyl) disulfide, bis(isocyanatoethyl) disulfide, bis(isocyanatomethylthio) methane, bis(isocyanatoethylthio) methane, bis(isocyanatoethylthio) ethane, and bis(isocyanatomethylthio) ethane; alicyclic polyisocyanate compounds such as isophorone diisocyanate, bis(isocyanatomethyl) cyclohexane, 1,2-bis(isocyanatomethyl) cyclohexane, 1,3-bis(isocyanatomethyl) cyclohexane, 1,4-bis(isocyanatomethyl) cyclohexane, dicyclohexyl methane diisocyanate, dicyclohexyl methane-4,4′-diisocyanate, dicyclohexyl methane-2,4′-diisocyanate, cyclohexane diisocyanate, methylcyclohexane diisocyanate, dicyclohexyldimethylmethane isocyanate, 2,5-bis(isocyanatomethyl)bicyclo-[2.2.1]-heptane, 2,6-bis(isocyanatomethyl)bicyclo-[2.2.1]-heptane, 3,8-bis(isocyanatomethyl) tricyclodecane, 3,9-bis(isocyanatomethyl) tricyclodecane, 4,8-bis(isocyanatomethyl) tricyclodecane, and 4,9-bis(isocyanatomethyl) tricyclodecane; aromatic polyisocyanate compounds such as diphenylsulfide-4,4-diisocyanate, tolylene diisocyanate, phenylene diisocyanate, 1,3-phenylene diisocyanate, 1,4-phenylene diisocyanate, and diphenylmethane diisocyanate; and heterocyclic polyisocyanate compounds such as 2,5-diisocyanatothiophene, 2,5-bis(isocyanatomethyl) thiophene, 2,5-diisocyanatotetrahydrothiophene, 2,5-bis(isocyanatomethyl) tetrahydrothiophene, 3,4-bis(isocyanatomethyl) tetrahydrothiophene, 2,5-diisocyanato-1,4-dithiane, 2,5-bis(isocyanatomethyl)-1,4-dithiane, 4,5-diisocyanato-1,3-dithiolane, and 4,5-bis(isocyanatomethyl)-1,3-dithiolane. As the polyisocyanate compound (A), at least one kind selected from these can be used.

As the polyisocyanate compound (A), the case of a modified product and/or a mixture with a modified product is also included, in addition to monomers, and examples of the modified product include multimers, biuret modified products, allophanate modified products, oxadiazinetrione modified products, and polyol modified products. Examples of the multimers include dimers such as uretdione, uretoimine, and carbodiimide, and multimers of tri- or higher mers such as isocyanurate and iminooxadiazine dione.

As the polyisocyanate compound (A), hexamethylene diisocyanate, pentamethylene diisocyanate, m-xylylene diisocyanate, isophorone diisocyanate, bis(isocyanatomethyl) cyclohexane, dicyclohexylmethane diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, or diphenylmethane diisocyanate is preferable, and m-xylylene diisocyanate, bis(isocyanatomethyl) cyclohexane, dicyclohexylmethane diisocyanate, 2,5-bis(isocyanatomethyl)bicyclo-[2.2.1]-heptane, or 2,6-bis(isocyanatomethyl)bicyclo-[2.2.1]-heptane is more preferable. These polyisocyanate compounds may be used alone or used as a mixture of two or more kinds thereof.

[Polyol Compound (B)]

In the present embodiment, as the polyol compound (B), at least one kind of compounds selected from the compounds represented by the following General Formula (1) having a number average molecular weight of 100 or more can be used.

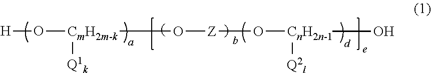

The lower limit of the number average molecular weight of the polyol compound (B) is 100 or more, preferably 200 or more, more preferably 300 or more, and still more preferably 400 or more, and the upper limit thereof is 4000 or less, preferably 3000 or less, and more preferably 2000 or less. The upper limit and the lower limit can be suitably combined.

In Formula (1), m represents a numerical value of 1 to 20, preferably a numerical value of 1 to 10, and more preferably a numerical value of 2 to 5.

n represents a numerical value of 1 to 20, preferably a numerical value of 1 to 10, and more preferably a numerical value of 2 to 5.

a represents a numerical value of 0 or more, preferably a numerical value of 0 to 100, and more preferably a numerical value of 0 to 25.

b represents a numerical value of 0 or more, preferably a numerical value of 0 to 200, and more preferably a numerical value of 0 to 100.

d represents a numerical value of 0 or more, preferably a numerical value of 1 to 200, and more preferably a numerical value of 1 to 100.

e represents a numerical value of 1 or more, preferably a numerical value of 1 to 200, and more preferably a numerical value of 1 to 100.

k represents 0 to 2m, and 1 represents 0 to 2n.

Q¹ represents a hydrogen atom or an alkyl group having 1 to 6 carbon atoms, and preferably a hydrogen atom or an alkyl group having 1 to 3 carbon atoms. A plurality of Q^{1,} s may be the same as or different from each other.

Q² represents a hydrogen atom or an alkyl group having 1 to 6 carbon atoms, and preferably a hydrogen atom or an alkyl group having 1 to 3 carbon atoms. A plurality of Q²'s maybe the same as or different from each other.

Z is a divalent organic group having 1 to 30 carbon atoms which optionally include an aromatic group, and preferably a divalent organic group having 1 to 20 carbon atoms which optionally include an aromatic group. A plurality of Z's maybe the same as or different from each other.

Examples of the “divalent organic group having 1 to 30 carbon atoms which optionally include an aromatic group” include substituted or unsubstituted linear or cyclic aliphatic groups having 1 to 30 carbon atoms such as a methylene group, an ethylene group, a trimethylene group, a tetramethylene group, a pentamethylene group, a cyclopentylene group, a hexamethylene group, a cyclohexylene group, a heptamethylene group, an octamethylene group, a nonamethylene group, a decamethylene group, an undecamethylene group, a dodecamethylene group, a tridecamethylene group, a tetradecamethylene group, and a pentadecamethylene group; substituted or unsubstituted aromatic groups having 6 to 30 carbon atoms such as a phenylene group, a naphthylene group, an anthracene group, a diphenylmethane group, a 1,1-diphenylethane group, a 1,1,1-methyldiphenylethane group, a diphenylpropane group, a diphenylether group, a diphenylsulfide group, a diphenylsulfoxide group, a diphenylsulfone group, a diphenylketone group, a phenylbenzoate group, a biphenyl group, a stilbene group, a diazobenzene group, and an aniline benzylidene group; substituted or unsubstituted aromatic-aliphatic groups having 6 to 30 carbon atoms such as a —C₆H₄—CH₂— group, a —CH₂—C₆H₄—CH₂— group, a —CH₂—C₆B₃(Cl)—CH₂— group, a —C₁₀H₆—CH₂— group, a —CH₂—C₁₀H₆—CH₂— group, and a —CH₂CH₂—C₆H₄—CH₂CH₂— group; and carbonyl group-containing compounds having 1 to 30 carbon atoms such as —C(O)—R⁷—C(O)— (R⁷ represents a substituted or unsubstituted linear or branched alkylene group having 1 to 20 carbon atoms or a substituted or unsubstituted aromatic group having 6 to 20 carbon atoms) and —C(O)—R⁸— (R⁸ represents a substituted or unsubstituted linear or branched alkylene group having 1 to 20 carbon atoms).

These organic groups maybe substituted with a linear or branched alkyl group having 1 to 10 carbon atoms or a linear or branched alkoxy group having 1 to 10 carbon atoms.

To impart good color-developing property to the polymer (molded product) obtained from the polymerizable composition of the present embodiment, it is necessary to set the molecular weight of the polyol compound (B) to be added to a suitable range.

In the present embodiment, as the polyol compound (B), at least one kind of compounds selected from the compounds represented by each of General Formulas (I) to (IV) can be used.

(Compound Represented by General Formula (I))

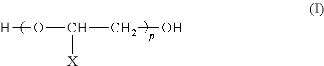

In Formula (I), p represents a numerical value of 4 to 100, and preferably a numerical value of 15 to 50. X represents a hydrogen atom or a methyl group, and a plurality of X's may be the same as or different from each other. X is preferably a methyl group.

Examples of the compound represented by General Formula (I) include polyethylene glycol and polypropylene glycol. These may include a low molecular oligomer such as ethylene glycol, diethylene glycol, or triethylene glycol, and may be used alone or used as a mixture of two or more kinds thereof.

The lower limit of the number average molecular weight of the compound represented by General Formula (I) is 100 or more, preferably 200 or more, more preferably 300 or more, and still more preferably 400 or more, and the upper limit thereof is 4000 or less, preferably 3000 or less, and more preferably 2000 or less. The upper limit and the lower limit can be suitably combined.

In a case where the number average molecular weight of the compound represented by General Formula (I) is within the above range, it is possible to effectively exhibit photochromic property without impairing characteristics such as high mechanical strength of a poly(thio)urethane resin.

For example, in a case where the compound represented by General Formula (I) is polyethylene glycol, when the number average molecular weight is less than 400, improvement of the color-developing property is not sufficiently obtained in some cases, and when the number average molecular weight is greater than 2000, the polymer becomes clouded, in some cases.

In a case where the compound represented by General Formula (I) is polypropylene glycol, when the number average molecular weight is less than 400, improvement of the color-developing property is not sufficiently obtained in some cases, and when the number average molecular weight is greater than 1000, the polymer becomes clouded, in some cases.

In addition, the obtained polymer in the case of polypropylene glycol exhibits higher heat resistance and rigidity than that in the case of polyethylene glycol. Accordingly, in applications used in various environments or conditions, such as lenses for spectacles, polypropylene glycol is more preferable than polyethylene glycol in some cases.

(Compound Represented by General Formula (II))

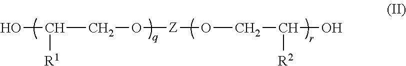

In Formula (II), q and r may be the same as or different from each other, each of q and r represents a numerical value of 1 or more, and preferably a numerical value of 6 to 25. q and r take numerical values such that the sum of q and r satisfies a numerical value of 2 to 100, and preferably a numerical value of 12 to 50.

R¹ and R² may be the same as or different from each other, each of R¹ and R² represents a hydrogen atom or a methyl group, and a plurality of R¹'s or R²'s may be the same as or different from each other.

Z represents a substituted or unsubstituted divalent aromatic group or a divalent aliphatic group which optionally include a substituted or unsubstituted aromatic group having 1 to 20 carbon atoms. Moreover, Z does not include -Ph-C(CH₃)₂-Ph- (Ph: phenylene group).

Examples of the substituted or unsubstituted divalent aromatic group include a phenylene group, a naphthylene group, an anthracene group, a diphenylmethane group, a 1,1-diphenylethane group, a 1,1,1-methyldiphenylethane group, a 1,3-diphenylpropane group, a 1,2-diphenylpropane group, a diphenylether group, a diphenylsulfide group, a diphenylsulfoxide group, a diphenylsulfone group, a diphenylketone group, a phenylbenzoate group, a biphenyl group, a stilbene group, a diazobenzene group, an aniline benzylidene group, and derivatives thereof.

Examples of the divalent aliphatic group which optionally include a substituted or unsubstituted aromatic group having 1 to 20 carbon atoms include divalent groups derived from a substituted or unsubstituted alkylene group having 1 to 20 carbon atoms and a bisalkoxy aromatic compound having 1 to 20 carbon atoms.

Examples of the substituted or unsubstituted alkylene group having 1 to 20 carbon atoms include a butylene group, a pentylene group, and a nonylene group.

Examples of the bisalkoxy aromatic compound having 1 to 20 carbon atoms include 1,4-bis(hydroxyethoxy) benzene, (1,3-bis (m-hydroxyethoxy) benzene, and 2,2-[(1,1-biphenyl)-4,4-diylbis(oxy)] bisethanol.

Examples of the substituent of a divalent aromatic group or a divalent aliphatic group include an alkyl group having 1 to 10 carbon atoms and an alkoxy group having 1 to 10 carbon atoms.

In the present embodiment, Z is preferably a phenylene group, a naphthylene group, or a biphenylene group.

Examples of the compound represented by General Formula (II) include polyethylene glycol adducts or polypropylene glycol adducts such as 1,4-butanediol, 3-methyl-1,5-pentanediol, 1,9-nonanediol, 1,4-bis(hydroxyethoxy) benzene, 1,3-bis(m-hydroxyethoxy) benzene, and 2,2[(1,1-biphenyl)-4,4-diylbis(oxy)] bisethanol, and these may be used alone or used as a mixture of two or more kinds thereof.

Moreover, the compound represented by General Formula (II) does not include the compound represented by General Formula (III).

The lower limit of the number average molecular weight of the compound represented by General Formula (II) is 200 or more, preferably 300 or more, more preferably 400 or more, and still more preferably 500 or more, and the upper limit thereof is 4000 or less, preferably 3000 or less, more preferably 2000 or less, and still more preferably 1000 or less. The upper limit and the lower limit can be suitably combined.

In a case where the number average molecular weight of the compound represented by General Formula (II) is within the above range, it is possible to effectively exhibit photochromic property without impairing characteristics such as high mechanical strength of a poly(thio)urethane resin.

(Compound Represented by General Formula (III))

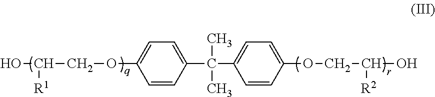

In Formula (III), q and r may be the same as or different from each other, each of q and r represents a numerical value of 1 or more, and preferably a numerical value of 6 to 25. q and r take numerical values such that the sum of q and r satisfies a numerical value of 2 to 100, and preferably a numerical value of 12 to 50.

R¹ and R² may be the same as or different from each other, each of R¹ and R² represents a hydrogen atom or a methyl group, and a plurality of R¹'s or R²'s may be the same as or different from each other.

Examples of the compound represented by General Formula (III) include polyethylene glycol adducts of bisphenol A and polypropylene glycol adducts of bisphenol A, and these may be used alone or used as a mixture of two or more kinds thereof.

The lower limit of the number average molecular weight of the compound represented by General Formula (III) is 200 or more, preferably 300 or more, more preferably 400 or more, and still more preferably 500 or more, and the upper limit thereof is 4000 or less, preferably 3000 or less, more preferably 2000 or less, and still more preferably 1500 or less. The upper limit and the lower limit can be suitably combined.

In a case where the number average molecular weight of the compound represented by General Formula (III) is within the above range, it is possible to effectively exhibit photochromic property without impairing characteristics such as high mechanical strength of a poly(thio)urethane resin.

For example, in a case where the compound represented by General Formula (III) is a polyethylene glycol adduct of bisphenol A or a polypropylene glycol adduct of bisphenol A, when the number average molecular weight is less than 400, improvement of the color-developing property is not sufficiently obtained in some cases, and when the number average molecular weight is greater than 1000, the polymer becomes clouded, in some cases.

(Compound Represented by General Formula (IV))

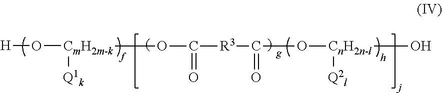

In Formula (IV), m represents a numerical value of 1 to 20, preferably a numerical value of 1 to 10, and more preferably a numerical value of 2 to 5.

n represents a numerical value of 1 to 20, preferably a numerical value of 1 to 10, and more preferably a numerical value of 2 to 5.

f represents a numerical value of 0 or more, preferably a numerical value of 0 to 100, and more preferably a numerical value of 0 to 25.

g represents a numerical value of 1 or more, preferably a numerical value of 1 to 200, and more preferably a numerical value of 1 to 100.

h represents a numerical value of 1 or more, preferably a numerical value of 1 to 200, and more preferably a numerical value of 1 to 100.

j represents a numerical value of 1 or more, preferably a numerical value of 1 to 200, and more preferably a numerical value of 1 to 100.

k represents 0 to 2m, and 1 represents 0 to 2n.

Q¹ represents a hydrogen atom or an alkyl group having 1 to 6 carbon atoms, and preferably a hydrogen atom or an alkyl group having 1 to 3 carbon atoms. A plurality of Q¹'s may be the same as or different from each other.

Q² represents a hydrogen atom or an alkyl group having 1 to 6 carbon atoms, and preferably a hydrogen atom or an alkyl group having 1 to 3 carbon atoms. A plurality of Q²'s maybe the same as or different from each other.

R³ represents a linear or branched alkylene group having 1 to 20 carbon atoms or a phenylene group which optionally have a linear or branched alkyl group having 1 to 10 carbon atoms as a substituent. A plurality of R³'s may be the same as or different from each other.

Examples of the compound represented by General Formula (IV) include a polyether compound formed of a diol compound and a dicarboxylic acid.

Although the diol compound configuring the polyester compound is not particularly limited, an aliphatic diol having 2 to 12 carbon atoms in the main chain is suitably used, and examples thereof include ethylene glycol, propylene glycol, 1,4-butanediol, 3-methyl-1,5-pentanediol, and 1,9-nonanediol.

In addition, although dicarboxylic acid configuring the polyester compound is not particularly limited, an aliphatic dicarboxylic acid or an aromatic dicarboxylic acid having 2 to 12 carbon atoms in the main chain is suitably used, and examples thereof include succinic acid, adipic acid, sebacic acid, isophthalic acid, and terephthalic acid.

The polyester compound can be formed by using one kind or two or more kinds of diol compounds and one kind or two or more kinds of dicarboxylic acids in suitable combination.

In addition, a polyester compound obtained by ring-opening polymerization of lactone can also be used in the present invention. Examples of the lactone compound include α-acetolactone, β-propiolactone, γ-butyrolactone, and δ-valerolactone.

The lower limit of the number average molecular weight of the compound represented by General Formula (IV) is 600 or more, preferably 800 or more, more preferably 1000 or more, and the upper limit thereof is 4000 or less, preferably 3000 or less, and more preferably 2000 or less. The upper limit and the lower limit can be suitably combined.

In a case where the number average molecular weight of the compound represented by General Formula (IV) is within the above range, it is possible to effectively exhibit photochromic property without impairing characteristics such as high mechanical strength of a poly(thio)urethane resin.

For example, in a case where the compound represented by General Formula (IV) is a polyester compound obtained by reacting an equimolar mixture of adipic acid and isophthalic acid with 3-methyl-1,5-pentanediol in equimolar ratio, when the number average molecular weight is less than 1000, improvement of the color-developing property is not sufficiently obtained in some cases, and when the number average molecular weight is greater than 2000, the polymer becomes clouded, in some cases.

By using the polyol compound (B) formed of the compound as described above, it is possible to effectively exhibit photochromic property.

In the present embodiment, as the polyol compound (B), at least one kind of compounds selected from the compounds represented by General Formulas (I) to (IV) can be used, and from the viewpoint of the above-described effect, the compound represented by General Formula (I), (III), or (IV) can be preferably used.

In the present embodiment, the polyol compound (B) can be used within a range of 0.3 times by weight to 6 times by weight with respect to the weight of the di- or higher functional active hydrogen compound (C). In the present embodiment, the polyol compound (B) is used within the above range such that resin property required depending on the application is obtained while maintaining high photochromic property. The preferable range is 0.7 times by weight to 5 times by weight.

In a case where the times by weight of the polyol compound (B) to the active hydrogen compound (C) is within the above range, high photochromic property, that is, high color forming density and fast changes in density can be suitably exhibited. Furthermore, since the crosslinking density is within an optimal range, an optical material excellent in rigidity, surface hardness, heat resistance, and the like can be obtained.

[Di- or Higher Functional Active Hydrogen Compound (C)]

The di- or higher functional active hydrogen compound (C) (hereinafter, simply referred to as “active hydrogen compound (C)”) is not particularly limited, and examples thereof include polyol compounds, polythiol compounds, and thiol compounds having a hydroxy group. These can be used in suitable combination. Moreover, the active hydrogen compound (C) does not include the polyol compound (B).

Examples of the polyol compound include aliphatic polyols such as ethylene glycol, diethylene glycol, propylene glycol, dipropylene glycol, tripropylene glycol, butylene glycol, neopentyl glycol, glycerin, trimethylol ethane, trimethylol propane, ditrimethylol propane, butanetriol, 1,2-methyl glucoside, pentaerythritol, dipentaerythritol, tripentaerythritol, sorbitol, erythritol, threitol, ribitol, arabinitol, xylitol, allitol, mannitol, dorsitol, iditol, glycol, inositol, hexanetriol, triglycerose, diglyperol, triethylene glycol, polyethylene glycol, tris(2-hydroxyethyl) isocyanurate, cyclobutanediol, cyclopentane diol, cyclohexane diol, cycloheptane diol, cyclooctane diol, cyclohexane dimethanol, hydroxypropyl cyclohexanol, tricyclo[5.2.1.0^{2,6}]decane-dimethanol, bicyclo[4,3,0]-nonanediol, dicyclohexanediol, tricyclo[5,3,1,1]dodecanediol, bicyclo[4,3,0]nonanedimethanol, tricyclo[5,3,1,1]dodecane-diethanol, hydroxypropyl tricyclo[5,3,1,1]dodecanol, spiro[3,4]octanediol, butyl cyclohexanediol, 1,1′-bicyclohexylidenediol, cyclohexanetriol, maltitol, and lactose; aromatic polyols such as dihydroxynaphthalene, trihydroxynaphthalene, tetrahydroxynaphthalene, dihydroxybenzene, benzenetriol, biphenyl tetraol, pyrogallol, (hydroxynaphthyl) pyrogallol, trihydroxyphenanthrene, bisphenol A, bisphenol F, xylylene glycol, di(2-hydroxyethoxy) benzene, bisphenol A-bis-(2-hydroxyethylether), tetrabromobisphenol A, and tetrabromobisphenol A-bis-(2-hydroxyethylether); halogenated polyols such as dibromoneopentyl glycol; and polymeric polyols such as an epoxy resin. In the present embodiment, at least one kind selected from these can be used in combination.

Additionally, examples of the polyol compound include condensation reaction products of an organic acid such as oxalic acid, glutamic acid, adipic acid, acetic acid, propionic acid, cyclohexanecarboxylic acid, β-oxocyclohexanepropionic acid, dimer acid, phthalic acid, isophthalic acid, salicylic acid, 3-bromopropionic acid, 2-bromoglycol, dicarboxycyclohexane, pyromellitic acid, butanetetracarboxylic acid, or bromophthalic acid with the above-described polyols; addition reaction products of the above-described polyols with an alkylene oxide such as ethylene oxide or propylene oxide; addition reaction product of an alkylenepolyamine with an alkylene oxide such as ethylene oxide or propylene oxide; bis-[4-(hydroxyethoxy)phenyl] sulfide, bis-[4-(2-hydroxypropoxy)phenyl] sulfide, bis-[4-(2,3-dihydroxypropoxy)phenyl] sulfide, bis-[4-(4-hydroxycyclohexyloxy)phenyl] sulfide, bis-[2-methyl-4-(hydroxyethoxy)-6-butylphenyl] sulfide, and compounds obtained by adding three molecules or less on average of ethylene oxide and/or propylene oxide per hydroxyl group to these compounds; and polyols containing a sulfur atom such as di-(2-hydroxyethyl) sulfide, 1,2-bis-(2-hydroxyethylmercapto) ethane, bis(2-hydroxyethyl) disulfide, 1,4-dithiane-2,5-diol, bis (2,3-dihydroxypropyl) sulfide, tetrakis(4-hydroxy-2-thiabutyl) methane, bis(4-hydroxyphenyl) sulfone (trade name: bisphenol S), tetrabromobisphenol S, tetramethyl bisphenol S, 4,4′-thiobis(6-tert-butyl-3-methylphenol), and 1,3-bis(2-hydroxyethylthioethyl)-cyclohexane. In the present embodiment, at least one kind selected from these can be used in combination.

Examples of the polythiol compound include aliphatic polythiol compounds such as methanedithiol, 1,2-ethanedithiol, 1,2,3-propanetrithiol, 1,2-cyclohexanedithiol, bis(2-mercaptoethyl) ether, tetrakis(mercaptomethyl) methane, diethylene glycol bis(2-mercaptoacetate), diethylene glycol bis(3-mercaptopropionate), ethylene glycol bis(2-mercaptoacetate), ethylene glycol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), bis(mercaptomethyl) sulfide, bis(mercaptomethyl) disulfide, bis(mercaptoethyl) sulfide, bis(mercaptoethyl) disulfide, bis(mercaptopropyl) sulfide, bis(mercaptomethylthio) methane, bis(2-mercaptoethylthio) methane, bis(3-mercaptopropylthio) methane, 1,2-bis(mercaptomethylthio) ethane, 1,2-bis(2-mercaptoethylthio) ethane, 1,2-bis(3-mercaptopropylthio) ethane, 1,2,3-tris(mercaptomethylthio) propane, 1,2,3-tris(2-mercaptoethylthio) propane, 1,2,3-tris(3-mercaptopropylthio) propane, 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, tetrakis(mercaptomethylthiomethyl) methane, tetrakis(2-mercaptoethylthiomethyl) methane, tetrakis(3-mercaptopropylthiomethyl) methane, bis(2,3-dimercaptopropyl) sulfide, 2,5-dimercaptomethyl-1,4-dithiane, 2,5-dimercapto-1,4-dithiane, 2,5-dimercaptomethyl-2,5-dimethyl-1,4-dithiane, and esters of these thioglycolic acid and mercaptopropionic acid, hydroxymethyl sulfide bis(2-mercaptoacetate), hydroxymethyl sulfide bis(3-mercaptopropionate), hydroxyethyl sulfide bis(2-mercaptoacetate), hydroxyethyl sulfide bis(3-mercaptopropionate), hydroxymethyl disulfide bis(2-mercaptoacetate), hydroxymethyl disulfide bis(3-mercaptopropionate), hydroxyethyl disulfide bis(2-mercaptoacetate), hydroxyethyl disulfide bis(3-mercaptopropionate), 2-mercaptoethyl ether bis(2-mercaptoacetate), 2-mercaptoethyl ether bis(3-mercaptopropionate), thiodiglycolic acid bis(2-mercaptoethylester), thiodipropionic acid bis(2-mercaptoethylester), dithiodiglycolic acid bis(2-mercaptoethyl ester), dithiodipropionic acid bis(2-mercaptoethylester), 1,1,3,3-tetrakis(mercaptomethylthio) propane, 1,1,2,2-tetrakis(mercaptomethylthio) ethane, 4,6-bis(mercaptomethylthio)-1,3-dithiane, tris(mercaptomethylthio) methane, and tris(mercaptoethylthio) methane; aromatic polythiol compounds such as 1,2-dimercaptobenzene, 1,3-dimercaptobenzene, 1,4-dimercaptobenzene, 1,2-bis(mercaptomethyl) benzene, 1,3-bis(mercaptomethyl) benzene, 1,4-bis(mercaptomethyl) benzene, 1,2-bis(mercaptoethyl) benzene, 1,3-bis(mercaptoethyl) benzene, 1,4-bis(mercaptoethyl) benzene, 1,3,5-trimercaptobenzene, 1,3,5-tris(mercaptomethyl) benzene, 1,3,5-tris(mercaptomethyleneoxy) benzene, 1,3,5-tris(mercaptoethyleneoxy) benzene, 2,5-toluenedithiol, 3,4-toluenedithiol, 1,5-naphthalenedithiol, and 2,6-naphthalenedithiol; heterocyclic polythiol compounds such as 2-methylamino-4,6-dithiol-sym-triazine, 3,4-thiophene dithiol, bismuthiol, 4,6-bis(mercaptomethylthio)-1,3-dithiane, and 2-(2,2-bis(mercaptomethylthio)ethyl)-1,3-dithietane; and a compound represented by the following General Formula (2), but the present invention is not limited to these exemplary compounds. In the present embodiment, at least one kind selected from these can be used in combination.

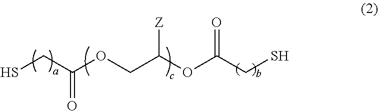

(in the formula, each of a and b independently represents an integer of 1 to 4, and c represents an integer of 1 to 3; and Z is a hydrogen atom or a methyl group, and in a case where a plurality of Z's are present, Z's may be the same as or different from each other)

Examples of the thiol compound having a hydroxy group include 2-mercaptoethanol, 3-mercapto-1,2-propanediol, glycerine bis(mercaptoacetate), 4-mercaptophenol, 2,3-dimercapto-1-propanol, pentaerythritol tris(3-mercaptopropionate), and pentaerythritol tris(thioglycolate), but the present invention is not limited to these exemplary compounds.

Furthermore, oligomers of these active hydrogen compounds or and halogen substitutes such as a chlorine substitute and a bromine substitute may be used. These active hydrogen compounds can be used alone or in combination of two or more kinds thereof.

In the present embodiment, as the active hydrogen compound (C), a tri- or higher functional active hydrogen compound is preferably used, from the viewpoint of the physical properties such as mechanical strength of the obtained molded product.

Specifically, at least one kind selected from glycerin, pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, 1,1,3,3-tetrakis(mercaptomethylthio) propane, and trimethylolpropane tris(3-mercaptopropionate) is preferably used.

In addition, examples of the preferable combination of the polyol compound (B) and the active hydrogen compound (C) include a combination of polyethylene glycol and at least one kind selected from glycerin, pentaerythritol tetrakis(2-mercaptoacetate), and 4-mercaptomethyl-1,8-dimercapto-3,6-dithiaoctane, a combination of polypropylene glycol and at least one kind selected from pentaerythritol tetrakis(2-mercaptoacetate) and 4-mercaptomethyl-1,8-dimercapto-3,6-dithiaoctane, a combination of a polypropylene glycol adduct of bisphenol A and 4-mercaptomethyl-1,8-dimercapto-3,6-dithiaoctane, and a combination of at least one kind selected from polyester compounds formed of 3-methyl-1,5-pentanediol, adipic acid, or isophthalic acid and 4-mercaptomethyl-1,8-dimercapto-3,6-dithiaoctane, but the present invention is not limited to these combinations.

[Photochromic Compound (D)]

In the present embodiment, the photochromic compound (D) is not particularly limited, and an arbitrary one can be suitably selected from compounds known in the related art which can be used for photochromic lenses and used. For example, at least one kind of a spiropyran-based compound, a spirooxazine-based compound, a fulgide-based compound, a naphthopyran-based compound, and a bisimidazole compound can be used depending on the desired color.

Examples of the spiropyran-based compound include each substitute obtained by substituting the indole ring or the benzene ring of indolinospirobenzopyran with a halogen atom, a methyl group, an ethyl group, a methylene group, an ethylene group, or a hydroxyl group, each substitute obtained by substituting the indole ring or the naphthalene ring of indolinospironaphthopyran with a halogen atom, a methyl group, an ethyl group, a methylene group, an ethylene group, or a hydroxyl group, each substitute obtained by substituting the indole ring of indolinospiroquinolinopyran with a halogen atom, a methyl group, an ethyl group, a methylene group, an ethylene group, or a hydroxyl group, and each substitute obtained by substituting the indole ring of indolinospiropyridopyran with a halogen atom, a methyl group, an ethyl group, a methylene group, an ethylene group, or a hydroxyl group.

Examples of the spirooxazine-based compound include each substitute obtained by substituting the indole ring or the benzene ring of indolinospirobenzoxazine with a halogen atom, a methyl group, an ethyl group, a methylene group, an ethylene group, or a hydroxyl group, each substitute obtained by substituting the indole ring or the naphthalene ring of indolinospironaphthoxazine with a halogen atom, a methyl group, an ethyl group, a methylene group, an ethylene group, or a hydroxyl group, each substitute obtained by substituting the indole ring of indolinospirophenanthroxazine with a halogen atom, a methyl group, an ethyl group, a methylene group, an ethylene group, or a hydroxyl group, each substitute obtained by substituting the indole ring of indolinospiroquinolinoxazine with a halogen atom, a methyl group, an ethyl group, a methylene group, an ethylene group, or a hydroxyl group, and each substitute obtained by substituting the piperidine ring and the naphthalene ring of piperidinospironaphthoxazine with a halogen atom, a methyl group, an ethyl group, a methylene group, an ethylene group, or a hydroxyl group.

Examples of the fulgide-based compound include N-cyanomethyl-6,7-dihydro-4-methyl-2-phenylspiro(5,6-benzo[b]thiophenedicarboximide-7,2′-tricyclo[3.3.1.1^{3,7}]decane], N-cyanomethyl-6,7-dihydro-2-(p-methoxyphenyl)-4-methylspiro(5,6-benzo[b]thiophene-dicarboximide-7,2′-tricyclo[3.3.1.1^{3,7}]decane), 6,7-dihydro-N-methoxycarbonylmethyl-4-methyl-2-phenylspiro(5,6-benzo[b]thiophene-dicarboximide-7,2′-tricyclo[3.3.1.1^{3,7}]decane), 6,7-dihydro-4-methyl-2-(p-methylphenyl)-N-nitromethylspiro(5,6-benzo[b]thiophenedicarboximide-7,2′-tricyclo[3.3.1.1^{3,7}]decane), N-cyanomethyl-6,7-dihydro-4-cyclopropyl-3-methylspiro(5,6-benzo[b]thiophenedicarboximide-7,2′-tricyclo[3.3.1.1^{3,7}]decane), N-cyanomethyl-6,7-dihydro-4-cyclopropylspiro(5,6-benzo[b]thiophenedicarboximide-7,2′-tricyclo[3.3.1.1^{3,7}]decane), and N-cyanomethyl-6,7-dihydro-2-(p-methoxyphenyl)-4-cyclopropylspiro (5,6-benzo[b]thiophenedicarboximide-7,2′-tricyclo[3.3.1.1^{3,7}]decane).

Examples of the naphthopyran-based compound include spiro[norbornane-2,2′-[2H]benzo[h]chromene], spiro[bicyclo[3.3.1]nonane-9,2′-[2H]benzo[h]chromene], 7′-methoxyspiro[bicyclo[3.3.1]nonane-9,2′-[2H]benzo[h]chromene], 7′-methoxyspiro[norbornane-2,2′-[2H]benzo[f]chromene], 2,2-dimethyl-7-octoxy[2H]benzo[h]chromene, spiro[2-bicyclo[3.3.1]nonene-9,2′-[2H]benzo[h]chromene], spiro[2-bicyclo[3.3.1]nonene-9,2′-[2H]benzo[f]chromene], 6-morpholino-3,3-bis(3-fluoro-4-methoxyphenyl)-3H-benzo (f)chromene, 5-isopropyl-2,2-diphenyl-2H-benzo (h)chromene, the compound represented by the following General Formula (3), and the compound represented by the following General Formula (4).

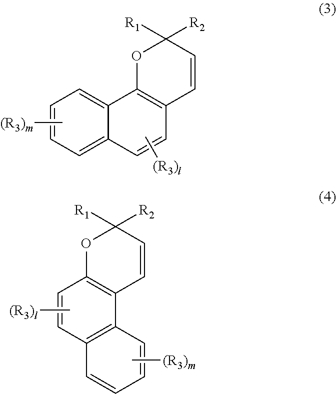

In General Formulas (3) and (4), R₁ and R₂ may be the same as or different from each other, and each of R₁ and R₂ independently represents a hydrogen atom;

a linear or branched alkyl group having 1 to 12 carbon atoms;

a cycloalkyl group having 3 to 12 carbon atoms;

an aryl group having 6 to 24 carbon atoms or a heteroaryl group having 4 to 24 carbon atoms which is substituted or unsubstituted; or

an aralkyl or heteroaralkyl group (a linear or branched alkyl group having 1 to 4 carbon atoms is substituted with an aryl group or a heteroaryl group).

The substituent of a substituted aryl group having 6 to 24 carbon atoms or a substituted heteroaryl group having 4 to 24 carbon atoms is at least one selected from a halogen atom, a hydroxy group, a linear or branched alkyl group having 1 to 12 carbon atoms, a linear or branched alkoxy group having 1 to 12 carbon atoms, a linear or branched haloalkyl group having 1 to 12 carbon atoms which is substituted with at least one halogen atom, a linear or branched haloalkoxy group having 1 to 12 carbon atoms which is substituted with at least one halogen atom, a phenoxy group or a naphthoxy group which is substituted with at least one linear or branched alkyl group or alkoxy group having 1 to 12 carbon atoms, a linear or branched alkenyl group having 2 to 12 carbon atoms, and an —NH₂ group, an —NHR group, or a —N(R)₂ group (R is a linear or branched alkyl group having 1 to 6 carbon atoms, and in a case where two Rs are present, the two Rs may be the same as or different from each other), and a methacryloyl group or an acryloyl group.

R₃'s may be the same as or different from each other, and each R³'s independently represents a halogen atom;

a linear or branched alkyl group having 1 to 12 carbon atoms; a cycloalkyl group having 3 to 12 carbon atoms;

a linear or branched alkoxy group having 1 to 12 carbon atoms;

a linear or branched haloalkyl group having 1 to 12 carbon atoms which is substituted with at least one halogen atom, a halocycloalkyl group having 3 to 12 carbon atoms which is substituted with at least one halogen atom, a linear or branched haloalkoxy group having 1 to 12 carbon atoms which is substituted with at least one halogen atom;

an aryl group having 6 to 24 carbon atoms or a heteroaryl group having 4 to 24 carbon atoms which is substituted or unsubstituted (which has at least one substituent selected from a halogen atom, a hydroxy group, a linear or branched alkyl group having 1 to 12 carbon atoms, a linear or branched alkoxy group having 1 to 12 carbon atoms, a linear or branched haloalkyl group having 1 to 12 carbon atoms which is substituted with at least one halogen atom, a linear or branched haloalkoxy group having 1 to 12 carbon atoms which is substituted with at least one halogen atom, a phenoxy group or a naphthoxy group which is substituted with at least one linear or branched alkyl group or alkoxy group having 1 to 12 carbon atoms, a linear or branched alkenyl group having 2 to 12 carbon atoms, and an amino group as a substituent);

an aralkyl or heteroaralkyl group (a linear or branched alkyl group having 1 to 4 carbon atoms is substituted with the aryl group or the heteroaryl group);

a substituted or unsubstituted phenoxy or naphthoxy group (which has at least one substituent selected from a linear or branched alkyl group or alkoxy group having 1 to 6 carbon atoms as a substituent);

—NH₂, —NHR, —CONH₂, or —CONHR (R is a linear or branched alkyl group having 1 to 6 carbon atoms); or

—OCOR₈ or —COOR₈ (here, R₈ is a linear or branched alkyl group having 1 to 6 carbon atoms, a cycloalkyl group having 3 to 6 carbon atoms, or a phenyl group which is substituted with at least one substituent of a substituted aryl group or a substituted heteroaryl group of R₁ and R₂ or an unsubstituted phenyl group).

It is possible to form at least one aromatic ring groups or non-aromatic ring groups by bonding of at least two adjacent R₃'s to each other and by including the carbon atom to which R₃ is bonded. The aromatic ring group or non-aromatic ring group includes one ring or two annelated rings which optionally include a heteroatom selected from the group consisting of oxygen, sulfur, and nitrogen.

l is an integer of 0 to 2. m is an integer of 0 to 4. Additionally, examples of the naphthopyran-based compound include compounds obtained by adding a light adjusting dye molecule to at least one terminal of each of a polysiloxane oligomer, a polyalkylene oxide, and a polyalkyl ester, described in WO2013/78086, WO2012/149599, WO2010/020770, and WO2009/146509, and a compound having two or more naphthopyran rings in one molecule by bonding of structures represented by General Formula (3) or (4) by a linking group.

Preferable examples of the naphthopyran-based compound represented by General Formula (3) include the compound represented by the following General Formula (5) (hereinafter, also referred to as the compound (5)).

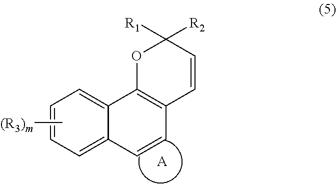

Each of R₁, R₂, R₃, and m has the same meaning as that described above, and A represents annelated rings represented by the following Formulas (A₁) to (A₅).

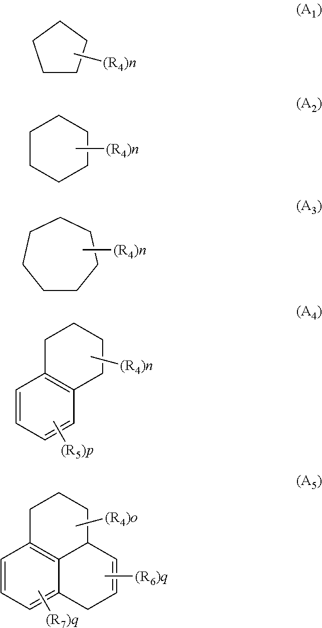

In these annelated rings (A₁) to (A₅), a dotted line represents a carbon C₅-carbon C₆ bond of the naphthopyran ring in General Formula (5). The a bond of the annelated ring (A₄) or (A₅) is bonded to the carbon C₅ or the carbon C₆ of the naphthopyran ring in General Formula (5).

R₄'s may be the same as or different from each other, and each

R₄'s independently represents OH or a linear or branched alkyl group or alkoxy group having 1 to 6 carbon atoms, or two R₄'s form a carbonyl group (CO).

Each of R₅, R₆, and R₇ independently represents a halogen atom (preferably, a fluorine atom, a chlorine atom, or a bromine atom);

a linear or branched alkyl group having 1 to 12 carbon atoms (preferably, a linear or branched alkyl group having 1 to 6 carbon atoms);

a linear or branched haloalkyl group having 1 to 6 carbon atoms which is substituted with at least one halogen atom (preferably, a fluoroalkyl group);

a cycloalkyl group having 3 to 12 carbon atoms;

a linear or branched alkoxy group having 1 to 6 carbon atoms;

a substituted or unsubstituted phenyl or benzyl group (which has at least one of substituents described above in the definition of R₁ and R₂ groups as a substituent in a case where each of R₁ and R₂ groups in General Formula (5) independently corresponds to an aryl or heteroaryl group);

—NH₂ or —NHR (here, R is a linear or branched alkyl group having 1 to 6 carbon atoms);

a substituted or unsubstituted phenoxy or naphthoxy group (which has at least a linear or branched alkyl group or alkoxy group having 1 to 6 carbon atoms as a substituent); or

a —COR₉, —COOR₉, or —CONHR₉ group (here, R₉ represents a linear or branched alkyl group having 1 to 6 carbon atoms, a cycloalkyl group having 3 to 6 carbon atoms, or a substituted or unsubstituted phenyl or benzyl group (which has at least one of substituents described above in the definition of R₁ and R₂ groups as a substituent in a case where each of R₁ and R₂ groups in General Formula (5) independently corresponds to an aryl or heteroaryl group)).

n is an integer of 0 to 6, o is an integer of 0 to 2, p is an integer of 0 to 4, and q is an integer of 0 to 3.

In a case where A represents (A₄), n is an integer of 0 to 2, and p is an integer of 0 to 4, and in a case where A represents (A₂), n is an integer of 0 to 2.

The photochromic compound (D) of General Formula (5) has high coloring adaptability even at 40° C. by being combined with the discoloration reaction rate that is applied to the use being required. The colors capable of being easily achieved are colors from orange to blue.

In the present embodiment, a mixture of the compound (5) belonging to at least one different kind selected from the group consisting of the compound (5) in which A is (A₁), the compound (5) in which A is (A₂), the compound (5) in which A is (A₉), the compound (5) in which A is (A₄), and the compound (5) in which A is (A₅) also is included.

In the present embodiment, as the compound (5), the compound represented by the following General Formula (6) can be preferably used.

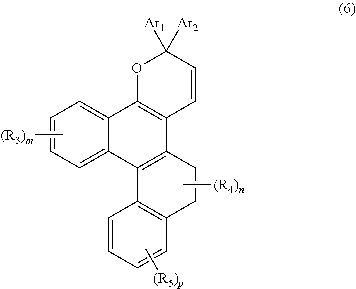

Ar₁ and Ar₂ are aromatic groups, and these may be the same as or different from each other, and each of Ar₁ and Ar₂ represents a benzene ring or a thiophene ring which optionally be substituted. As the substituent of the benzene ring or the thiophene ring, a linear or branched alkyl group having 1 to 10 carbon atoms, a linear or branched alkoxy group having 1 to 10 carbon atoms, or a linear or branched alkyl mono (or di) substituted amino group having 1 to 6 carbon atoms can be exemplified. Each of R₃, R₄, R₅, m, n, and p has the same meaning as that described above.

As the compound (5), the compound represented by the following General Formula (7) can be more preferably used.

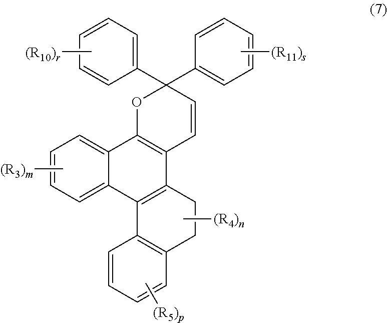

In Formula (7), R₁₀ and R₁₁ may be the same as or different from each other, and each of R₁₀ and R₁₁ represents a linear or branched alkyl group having 1 to 10 carbon atoms, a linear or branched alkoxy group having 1 to 10 carbon atoms, or a linear or branched alkyl mono (or di) substituted amino group having 1 to 6 carbon atoms. When m is 2, it is possible to form a ring structure by bonding of adjacent R₃'s to each other and by including the carbon atom to which R₃ is bonded. Each of r and s is an integer of 0 to 4. The above ring structure is a structure of an aryl group having 6 to 24 carbon atoms or a heteroaryl group having 3 to 24 carbon atoms which is substituted or unsubstituted.

Each of R₃, R₄, R₅, m, n, and p has the same meaning as that described above.

As specific examples of the compound represented by General Formula (7), the compound represented by the following Formula (8) or (9) is exemplified. In the present embodiment, the compound represented by Formula (8) or (9) is preferable.

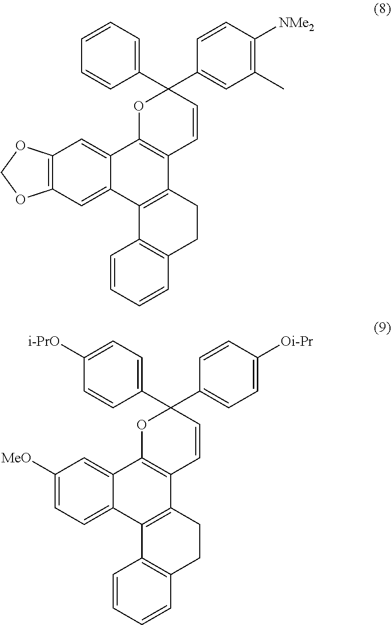

The compound represented by General Formula (5) which is the photochromic compound (D) can be synthesized by a known method. For example, the compound can also be synthesized by the method described in PCT Japanese Translation Patent Publication No. 2004-500319.

In addition, as specific examples of the naphthopyran-based compound represented by General Formula (3), the compound represented by the following Formula (10) can be preferably exemplified.

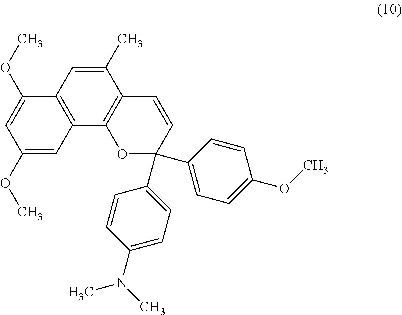

As the naphthopyran-based compound, at least one compounds selected from the above-described compounds may be used.

[Other Components]

In the present embodiment, in addition to the components (A) to (D), a polymerization catalyst, an internal mold release agent, a resin modifier, or the like may be further included in the polymerizable composition for optical materials.

Examples of the polymerization catalyst include a tertiary amine compound and an inorganic acid salt or an organic acid salt thereof, a metal compound, a quaternary ammonium salt, and an organic sulfonic acid.

An acidic phosphoric ester can be used as the internal mold release agent. Examples of the acidic phosphoric ester include a phosphoric monoester and a phosphoric diester, and the acidic phosphoric ester can be used alone or in a mixture of two or more kinds thereof.

Examples of the resin modifier include olefin compounds and the like including an episulfide compound, an alcohol compound, an amine compound, an epoxy compound, an organic acid and an anhydride thereof, or a (meth)acrylate compound.

<Process for Producing Polymerizable Composition for Optical Materials>

The polymerizable composition for optical materials of the present embodiment can be prepared by mixing the isocyanate compound (A), the polyol compound (B), the active hydrogen compound (C), and the photochromic compound (D).

In the present embodiment, the lower limit of the functional group equivalent ratio (B/A) of the polyol compound (B) to the polyisocyanate compound (A) is 0.02 or more, preferably 0.10 or more, more preferably 0.15 or more, still more preferably 0.20 or more, and particularly preferably 0.25 or more, and the upper limit thereof is 0.60 or less, preferably 0.50 or less, more preferably 0.40 or less, and still more preferably 0.30 or less. The upper limit and the lower limit can be suitably combined.

The lower limit of the functional group equivalent ratio (C/A) of the active hydrogen compound (C) to the polyisocyanate compound (A) is 0.30 or more, preferably 0.40 or more, more preferably 0.50 or more, and still more preferably 0.60 or more, and the upper limit thereof is 0.99 or less, preferably 0.98 or less, more preferably 0.90 or less, and still more preferably 0.80 or less. The upper limit and the lower limit can be suitably combined.

In a case where the equivalent ratio is within the above range, high photochromic property can be exhibited, and an optical material which is excellent in terms of balance, having excellent mechanical properties which are the features of a poly (thio) urethane-based resin, can be provided.

For example, in a case where the compound represented by General Formula (I) is polyethylene glycol, when the functional group equivalent ratio (B/A) is less than 0.1, improvement of the color-developing property is not sufficiently obtained, in some cases. When the functional group equivalent ratio (B/A) is greater than 0.6, the polymer becomes clouded, in some cases.

In addition, in a case where the compound represented by General Formula (I) is polypropylene glycol, when the functional group equivalent ratio (B/A) is less than 0.06, improvement of the color-developing property is not sufficiently obtained, in some cases. When the functional group equivalent ratio (B/A) is greater than 0.6, the polymer becomes clouded, in some cases.

In addition, for the compound represented by General Formula (II), when the functional group equivalent ratio (B/A) is less than 0.06, improvement of the color-developing property is not sufficiently obtained, in some cases. When the functional group equivalent ratio (B/A) is greater than 0.6, the polymer becomes clouded, in some cases.

In addition, in a case where the compound represented by General Formula (III) is a polyethylene glycol adduct of bisphenol A or a polypropylene glycol adduct of bisphenol A, when the functional group equivalent ratio (B/A) is less than 0.06, improvement of the color-developing property is not sufficiently obtained, in some cases. In addition, when the functional group equivalent ratio (B/A) is greater than 0.6, the polymer becomes clouded, in some cases.

In addition, in a case where the compound represented by General Formula (IV) is a polyester compound obtained by reacting an equimolar mixture of adipic acid and isophthalic acid with 3-methyl-1,5-pentanediol in equimolar ratio, when the functional group equivalent ratio (B/A) is less than 0.02, improvement of the color-developing property is not sufficiently obtained, in some cases. When the functional group equivalent ratio (B/A) is greater than 0.2, the polymer becomes clouded, in some cases.

In the composition, the molar ratio (NCO group/(OH group and SH group)) of the NCO groups in the polyisocyanate compound (A) to the total sum of the OH groups and the SH groups in the polyol compound (B) and the active hydrogen compound (C) is typically within a range of 0.8 to 1.2, preferably within a range of 0.85 to 1.15, and more preferably within a range of 0.9 to 1.1.

Ina case where the molar ratio of NCO group/(OH group+SH group) is 0.8 or more, an unreacted OH group or SH group does not remain, the composition is sufficiently cured, and thus, a resin excellent in heat resistance, moisture resistance, and light-fastness is obtained, and in a case where the ratio of NCO group/(OH group+SH group) is 1.2 or less, an unreacted NCO group does not remain, a resin excellent in heat resistance, moisture resistance, and light-fastness is obtained, there is no need to raise the reaction temperature to reduce the unreacted NCO groups, disadvantages such as coloring are not showed, and thus, the resin is preferable as the resin material.

The photochromic compound (D) can be used within a range of 10 ppm to 5000 ppm with respect to the total amount of the isocyanate compound (A), the polyol compound (B), and the active hydrogen compound (C).

The temperature in a case where a polymerizable composition is prepared by mixing the polyisocyanate compound (A), the polyol compound (B), the active hydrogen compound (C), the photochromic compound (D), and other additives is typically 25° C. or lower. There are cases in which the temperature is preferably a lower temperature from the viewpoint of a pot life of the polymerizable composition. However, in a case in which the solubility of the catalyst, the internal mold release agent, and the additives in the monomer are not favorable, it is also possible to dissolve the catalyst, the internal mold release agent, and the additives in the monomer and the resin modifier by heating the catalyst, the internal mold release agent, and the additive in advance.

The mixing order or the mixing method of respective components in the composition is not particularly limited as long as the respective components can be homogeneously mixed by the mixing order or the mixing method, and the mixing can be performed by a known method. Examples of the known method include a method in which a master batch including a predetermined amount of additives is prepared, and the master batch is dispersed and dissolved in a solvent.

In the present embodiment, a process for producing optical materials is not particularly limited, but preferable examples of the production method include cast polymerization. First, the polymerizable composition is injected into a mold held using a gasket, tape, or the like. At this time, there are many cases in which a degassing treatment, a filtration treatment such as pressurization or depressurization, and the like under reduced pressure are preferably carried out as necessary depending on physical properties that obtained plastic lenses require.

Since polymerization conditions significantly vary depending on the composition ratio of the polymerizable composition, the kinds and the amount of the catalyst used, the shape of the mold, and the like, the polymerization conditions are not limited, but the polymerization is performed at a temperature of −50° C. to 150° C. over a period of 1 hour to 50 hours. Depending on cases, the polymerizable composition is preferably held in a temperature range of 10° C. to 150° C. or slowly heated, and cured for 1 hour to 25 hours.

The optical material may be subjected to a treatment such as annealing, as necessary. The treatment is performed typically at a temperature within a range of 50° C. to 150° C., and preferably performed at a temperature within a range of 90° C. to 140° C., and more preferably performed at a temperature within a range of 100° C. to 130° C.

In the present embodiment, when a resin is formed, in addition to the “other components”, various additives such as a chain extender, a crosslinking agent, a light stabilizer, an ultraviolet absorber, an antioxidant, a bluing agent, an oil-soluble dye, a filler, and an adhesion improver may be added according to the purpose, similarly to known molding methods.

<Uses>

The polymerizable composition of the present embodiment can be obtained as molded bodies having various shapes by changing the type of molds at the time of cast polymerization. Since the molded product has photochromic property, a high refractive index, and high transparency, the molded product can be used in various optical materials such as a plastic lens. In particular, the molded product can be suitably used in a plastic spectacle lens.

[Plastic Spectacle Lens]

Plastic spectacle lenses using a lens substrate comprised of the molded product of the present embodiment may be provided with a coating layer on a single surface or both surfaces thereof as necessary, and then used.

The plastic spectacle lens of the present embodiment is comprised of a lens substrate comprised of the polymerizable composition described above and a coating layer.

Specific examples of the coating layer include a primer layer, a hard coating layer, an antireflection layer, an antifog coated layer, an antifouling layer, and a water-repellent layer. It is possible to solely use each of these coating layers, or it is possible to use after multilayering the plurality of coating layers. In a case where the coating layers are provided on both surfaces, similar coating layers may be provided, or different coating layers may be provided on the respective surfaces.

In the coating layers, an ultraviolet absorbent for the purpose of protecting lenses or eyes from ultraviolet rays, infrared absorbent for the purpose of protecting eyes from infrared rays, a light stabilizer or an antioxidant for the purpose of improving weather resistance of lenses, a dye or a pigment for the purpose of improving fashionability of lenses, an antistatic agent, and other well-known additives for enhancing propertys of lenses may respectively be jointly used. For layers coated by coating, a variety of leveling agents may be used for the purpose of improving coatability.

The primer layer is typically formed between the hard coating layer described below and a lens. The primer layer is a coating layer having a purpose of improving adhesion between the hard coating layer formed on the primer layer and the lens, and, depending on cases, it is also possible to improve impact resistance. Although any material can be used for the primer layer as long as it has high adhesion to an obtained lens, typically, a primer composition or the like including a urethane-based resin, an epoxy-based resin, a polyester-based resin, a melanin-based resin, and polyvinyl acetal, as a main component, is used. For the primer composition, a suitable solvent having no influence on lenses may be used for the purpose of adjusting a viscosity of the composition. It is needless to say that the primer composition may be used without a solvent.

The primer layer can be formed by any one of a coating method and a dry method. In a case where the coating method is used, the primer layer is formed by applying the primer composition to a lens by a well-known coating method such as a spin coating or a dip coating, and then solidifying the primer composition. In a case where the dry method is performed, the primer layer is formed by a well-known dry method such as a CVD method or a vacuum deposition method. When the primer layer is formed, a pretreatment such as an alkali treatment, a plasma treatment, or an ultraviolet treatment may be performed on surfaces of a lens as necessary for the purpose of improving adhesion.

The hard coating layer is a coating layer for the purpose of imparting functions of abrasion resistance, wear resistance, moisture resistance, warm water resistance, heat resistance, weather resistance, and the like to the surfaces of a lens.

As the hard coating layer, a hard coating composition including at least one kind of fine particles made up of a curable organic silicon compound and fine particles of at least one oxide of elements selected from an element group of Si, Al, Sn, Sb, Ta, Ce, La, Fe, Zn, W, Zr, In, and Ti and/or a composite oxide of at least two elements selected from the above element group is generally used.

The hard coating composition preferably includes at least any one of amines, amino acids, metal acetylacetonate complexes, organic acid metallic salts, perchloric acids, salts of perchloric acids, acids, metallic chlorides, and polyfunctional epoxy compounds, in addition to the above-described components. For the hard coating composition, a suitable solvent having no influence on lenses may be used, or the composition may be used without a solvent.

The hard coating layer is typically formed by coating with the hard coating composition by a well-known coating method such as a spin coating or a dip coating, and then curing the composition. Examples of a curing method include a curing method in which thermal curing or radiation of energy rays, such as ultraviolet rays or visible light rays, is used. A refractive index of the hard coating layer is preferably within a range of a difference of ±0.1 from the refractive index of the lens in order to suppress the occurrence of interference fringe.

The antireflection layer is typically formed on the hard coating layer as necessary. There are inorganic antireflection layers and organic antireflection layers, and the inorganic antireflection layers are formed using an inorganic oxide such as SiO₂ or TiO₂ by a dry method such as a vacuum deposition method, a sputtering method, an ion plating method, an ion beam assisting method, or a CVD method. The organic antireflection layers are formed using a composition including an organic silicon compound and silica-based fine particles having internal cavities by a wet method.

Single antireflection layer or multiple antireflection layers may be provided, and, in a case where single antireflection layer is used, the refractive index of the antireflection layer is preferably smaller than the refractive index of the hard coating layer by at least 0.1 or more. In order to effectively develop an antireflection function, it is preferable to form multiple antireflection films, and, in this case, films having a low refractive index and films having a high refractive index are alternately stacked. Even in this case, a difference in the refractive index between the films having a low refractive index and the films having a high refractive index is preferably 0.1 or more. Examples of the film having a high refractive index include films of ZnO, TiO₂, CeO₂, Sb₂O₅, SnO₂, ZrO₂, Ta₂O₅, and the like, and examples of the film having a low refractive index include films of SiO₂, and the like.

An antifog layer, an antifouling layer, or a water-repellent layer may be formed on the antireflection layer, as necessary. Regarding methods for forming an antifog layer, an antifouling layer, and a water-repellent layer, treatment methods, treatment materials, and the like are not particularly limited as long as no adverse influences are brought to the antireflection function, and well-known antifog treatment methods, antifouling treatment methods, water-repellency-providing treatment methods, and materials can be used. Examples of the antifog treatment method and the antifouling treatment method include a method in which the surface is covered with a surfactant, a method in which a hydrophilic film is added to the surface so as to provide water absorbability, a method in which the surface is coated with fine irregularity so as to enhance water absorbability, a method in which a photocatalytic activity is used so as to provide water absorbability, and a method in which a super water-repellency-providing treatment is carried out so as to prevent attachment of water droplets. In addition, examples of the water-repellency-providing treatment method include a method in which a water-repellency-provided layer is formed using a fluorine-containing silane compound or the like and deposition or sputtering and a method in which a fluorine-containing silane compound is dissolved in a solvent and then applied so as to form a water-repellency-provided layer.

### EXAMPLES

Next, the present invention is described in more detail based on examples, but the present invention is not limited to these examples. Moreover, in the examples and comparative examples, the methods and equipment used in evaluation are as follows.

(a) The amount of changes (ΔT % max) in light transmittance before and after coloring: under the conditions of the ultraviolet intensity of 1.2 mW/cm² measured by an accumulated light quantity meter at a temperature of 19° C. using a metal halide lamp (180 W) light source device, a molded product sample processed into a thickness of 2.0 mm was colored for 5 minutes. Spectroscopies were measured by a transmission measurement system before and after coloring, and the amount of changes in light transmittance before and after coloring was determined by the following equation.

Amount of changes (ΔT % max) in light transmittance before and after coloring=light transmittance (T % max) at maximum absorption wavelength (λmax) at the time of coloring−light transmittance (T % 0) at (λmax) before coloring

As the amount of changes in light transmittance is increased, light becomes brighter at the time of color-fading, and the light shielding properties become higher at the time of coloring, and thus, the photochromic property becomes high.

(b) Color fading half-life (F1/2): the color fading half-life is defined as the time period necessary for the absorbance of the molded product sample at λmax to be recovered to an intermediate value of the absorbance before and after coloring from stopping irradiation with light rays after coloring for 5 minute described above. As the time period is shorter, the color fading rate is faster, and thus, the photochromic property becomes high.
Light source: a metal halide lamp light source device “LA-180ME” manufactured by HAYASHI WATCH-WORKS
Accumulated light quantity meter: an accumulated light quantity meter “UIT-102 (photodetector UVD365PD)” manufactured by USHIO Inc.
Transmission measurement system: “MV-3150” manufactured by JASCO Corporation

(c) Tension test: using an autograph AGS-J manufactured by Shimadzu Corporation, steel shafts passed through two holes opened in a resin sample are pulled until the sample was broken at a rate of 5 mm per minute, and the stress at the time when the sample was elongated to the yielding point was recorded as the tensile strength. As both numerical values are increased, the material is not easily broken.
Tension test sample: holes having a diameter of 1.6 mm were opened at two points facing the diameter direction at the position 5.0 mm apart in the center direction from the outer periphery on a disc-shape molded product having a diameter of 45 mm and a thickness of 2.0 mm, and as a result, a tensile test sample was obtained.

### Example 1

0.05 parts by mass of a compound represented by Formula (9) as a photochromic compound and 0.15 parts by mass of dimethyltin dichloride were added to 49.6 parts by mass of 1,3-bis(isocyanatomethyl) cyclohexane, and the resultant product was mixed and stirred to dissolve the solid thereof. 40.9 parts by mass of polyethylene glycol having a number average molecular weight of 400 and 9.5 parts by mass of glycerin were added to this mixed liquid, and the resultant product was mixed and continuously stirred. When the solution became clear, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 575 nm) was 65.2% and the color fading half-life (F1/2) was 375 seconds were obtained. Furthermore, in the tension test, favorable results that the tensile strength was 32 kgf and the elongation was 12.6% were obtained. The results are shown in Table-1.

### Example 2

0.05 parts by mass of a compound represented by Formula (9) as a photochromic compound and 0.15 parts by mass of dimethyltin dichloride were added to 39.3 parts by mass of 1,3-bis(isocyanatomethyl) cyclohexane, and the resultant product was mixed and stirred to dissolve the solid thereof. 29.1 parts by mass of polyethylene glycol having a number average molecular weight of 400 and 31.6 parts by mass of pentaerythritol tetrakis(2-mercaptoacetate) were added to this mixed liquid, then, the resultant product was sufficiently mixed, stirred, and degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. When the photochromic property of the molded product was evaluated, the amount of changes (ΔT % max) in light transmittance before and after coloring at the maximum absorption wavelength (λmax: 575 nm) was 32.5%, and the color fading half-life (F1/2) was 1500 seconds. Furthermore, in the tension test, favorable results that the tensile strength was 38 kgf and the elongation was 5.9% were obtained. The results are shown in Table-1.

### Example 3

0.05 parts by mass of the compound represented by Formula (9) as a photochromic compound and 0.70 parts by mass of dimethyltin dichloride were added to 45.8 parts by mass of dicyclohexylmethane-4,4′-diisocyanate in the same manner as in Example 1, and the resultant product was mixed and stirred to dissolve the solid thereof. 28.4 parts by mass of polyethylene glycol having a number average molecular weight of 1000 and 25.8 parts by mass of 4-mercaptomethyl-1,8-dimercapto-3,6-dithiaoctane were added to this mixed liquid, and the resultant product was mixed to dissolve the solid thereof. When the solution became clear, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 575 nm) was 60.6% and the color fading half-life (F1/2) was 345 seconds were obtained. Next, when a tension test was performed on a tension test sample obtained from the molded product, results that the tensile strength was 45 kgf and the elongation was 7.7% were obtained. The results are shown in Table-1.

### Example 4

0.05 parts by mass of the compound represented by Formula (9) as a photochromic compound and 0.70 parts by mass of dimethyltin dichloride were added to 44.7 parts by mass of dicyclohexylmethane-4,4′-diisocyanate in the same manner as in Example 1, and the resultant product was mixed and stirred to dissolve the solid thereof. 27.7 parts by mass of polyethylene glycol having a number average molecular weight of 2000 and 27.6 parts by mass of 4-mercaptomethyl-1,8-dimercapto-3,6-dithiaoctane were added to this mixed liquid, and the resultant product was mixed to dissolve the solid thereof. When the solution became clear, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 575 nm) was 65.9% and the color fading half-life (F1/2) was 210 seconds were obtained. Furthermore, in the tension test, favorable results that the tensile strength was 39 kgf and the elongation was 6.9% were obtained. The results are shown in Table-1.

### Example 5

0.05 parts by mass of the compound represented by Formula (9) as a photochromic compound and 0.70 parts by mass of dimethyltin dichloride were added to 43.2 parts by mass of dicyclohexylmethane-4,4′-diisocyanate in the same manner as in Example 1, and the resultant product was mixed and stirred to dissolve the solid thereof. 33.5 parts by mass of polypropylene glycol having a number average molecular weight of 1000 and 23.3 parts by mass of 4-mercaptomethyl-1, 8-dimercapto-3,6-dithiaoctane were added to this mixed liquid, and the resultant product was mixed to dissolve the solid thereof. When the solution became clear, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 70.6% and the color fading half-life (F1/2) was 165 seconds were obtained. Furthermore, in the tension test, favorable results that the tensile strength was 34 kgf and the elongation was 7.8% were obtained. The results are shown in Table-1.

### Example 6

0.05 parts by mass of the compound represented by Formula (9) as a photochromic compound and 0.01 parts by mass of dimethyltin dichloride were added to 40.8 parts by mass of m-xylylene diisocyanate, and the resultant product was mixed and stirred to dissolve the solid thereof. 26.1 parts by mass of polyethylene glycol having a number average molecular weight of 1000 and 33.1 parts by mass of 4-mercaptomethyl-1,8-dimercapto-3,6-dithiaoctane were added to this mixed liquid, and the resultant product was mixed and stirred. When the solution became homogeneous, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 49.6% and the color fading half-life (F1/2) was 1100 seconds were obtained. Furthermore, in the tension test, favorable results that the tensile strength was 42 kgf and the elongation was 8.3% were obtained. The results are shown in Table-1.

### Example 7

0.05 parts by mass of the compound represented by Formula (9) as a photochromic compound and 0.01 parts by mass of dimethyltin dichloride were added to 40.8 parts by mass of m-xylylene diisocyanate, and the resultant product was mixed and stirred to dissolve the solid thereof. 26.1 parts by mass of polypropylene glycol having a number average molecular weight of 1000 and 33.1 parts by mass of 4-mercaptomethyl-1,8-dimercapto-3,6-dithiaoctane were added to this mixed liquid, and the resultant product was mixed and stirred. When the solution became homogeneous, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 75.5% and the color fading half-life (F1/2) was 115 seconds were obtained. Furthermore, in the tension test, favorable results that the tensile strength was 41 kgf and the elongation was 8.4% were obtained. The results are shown in Table-1.

### Example 8

0.05 parts by mass of the compound represented by Formula (9) as a photochromic compound and 0.10 parts by mass of dimethyltin dichloride were added to 42.8 parts by mass of 2,5(2,6)-bis(isocyanatomethyl)bicyclo[2.2.1] heptane, and the resultant product was mixed and stirred to dissolve the solid thereof. 25.2 parts by mass of polypropylene glycol having a number average molecular weight of 1000 and 32.0 parts by mass of 4-mercaptomethyl-1, 8-dimercapto-3,6-dithiaoctane were added to this mixed liquid, and the resultant product was mixed and stirred. When the solution became homogeneous, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 71.8% and the color fading half-life (F1/2) was 135 seconds were obtained. Furthermore, in the tension test, favorable results that the tensile strength was 50 kgf and the elongation was 6.7% were obtained. The results are shown in Table-1.

### Example 9

0.05 parts by mass of the compound represented by Formula (9) as a photochromic compound and 0.10 parts by mass of dimethyltin dichloride were added to 41.0 parts by mass of 2,5(2,6)-bis(isocyanatomethyl)bicyclo[2.2.1] heptane, and the resultant product was mixed and stirred to dissolve the solid thereof. 22.5 parts by mass of polypropylene glycol having a number average molecular weight of 700 and 36.5 parts by mass of pentaerythritol tetrakis(2-mercaptoacetate) were added to this mixed liquid, and the resultant product was mixed and stirred. When the solution became homogeneous, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 57.1% and the color fading half-life (F1/2) was 190 seconds were obtained. Furthermore, in the tension test, favorable results that the tensile strength was 58 kgf and the elongation was 6.9% were obtained. The results are shown in Table-1.

### Example 10

0.05 parts by mass of the compound represented by Formula (9) as a photochromic compound and 0.10 parts by mass of dimethyltin dichloride were added to 38.6 parts by mass of 2,5(2,6)-bis(isocyanatomethyl)bicyclo[2.2.1] heptane, and the resultant product was mixed and stirred to dissolve the solid thereof. 35.2 parts by mass of a polypropylene glycol adduct of 2,2-bis(4-hydroxyphenyl) propane (bisphenol A) having a number average molecular weight of 927 (701 in terms of addition PPG) and 26.2 parts by mass of 4-mercaptomethyl-1,8-dimercapto-3,6-dithiaoctane were added to this mixed liquid, and the resultant product was mixed and stirred. When the solution became homogeneous, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 55.1% and the color fading half-life (F1/2) was 1100 seconds were obtained. Furthermore, in the tension test, favorable results that the tensile strength was 59 kgf and the elongation was 7.4% were obtained. The results are shown in Table-1.

### Example 11

0.05 parts by mass of the compound represented by Formula (9) as a photochromic compound and 0.10 parts by mass of dimethyltin dichloride were added to 41.9 parts by mass of 2,5(2,6)-bis(isocyanatomethyl)bicyclo[2.2.1] heptane, and the resultant product was mixed and stirred to dissolve the solid thereof. 24.6 parts by mass of a polyester compound having a number average molecular weight of 2000 obtained by reacting an equimolar mixture of adipic acid and isophthalic acid with 3-methyl-1,5-pentanediol in equimolar ratio and 33.5 parts by mass of 4-mercaptomethyl-1,8-dimercapto-3,6-dithiaoctane were added to this mixed liquid, and the resultant product was mixed and stirred. When the solution became homogeneous, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple immediately after it was placed under solar light rays and being decolored when it was shielded from light rays. The photochromic property of the molded product was evaluated, and favorable results that the amount of changes (ΔT % max) in light transmittance before and after coloring at the maximum absorption wavelength (λmax: 570 nm) was 61.9% and the color fading half-life (F1/2) was 145 seconds were obtained. Furthermore, in the tension test, favorable results that the tensile strength was 56 kgf and the elongation was 7.0% were obtained. The results are shown in Table-1.

### Comparative Example 1

0.05 parts by mass of the compound represented by Formula (9) as a photochromic compound was dissolved in 100 parts by mass of a mixed solution of 50 parts by mass of 2,2′-bis[4-(methacryloyloxyethoxy)phenyl] propane and 50 parts by mass of triethylene glycol dimethacrylate, 1.0 part by mass of t-butyl peroxyneodecanoate as a polymerization initiator and 1.0 part by mass of 2,4-diphenyl-4-methyl-1-pentene as a polymerization degree adjusting agent were added thereto, then, the resultant product was mixed and degassed at 5 mmHg for 20 minutes, and this solution was injected into a sheet type mold formed of polyethylene. This was put into a furnace at 20° C. and kept for 8 hours, and the temperature was raised to 90° C. over a period of 12 hours. After the resultant product was heated at 90° C. for 3 hours, the mold was taken out from the furnace, and by removing the mold, a molded product obtained by polymerization was obtained (a disc-shape having a diameter of 45 mm and a thickness of 2.0 mm).

The molded product was colorless and transparent, and had favorable photochromic property of being colored purple under solar light rays and being decolored immediately after it was shielded from light rays. When the photochromic property of the molded product was evaluated, the amount of changes (ΔT % max) in light transmittance before and after coloring at the maximum absorption wavelength (λmax: 575 nm) was 75.4%, and the color fading half-life (F1/2) was 255 seconds. When a tension test was performed on a tension test sample obtained from the molded product, results that the tensile strength was 14 kgf and the elongation was 0.9% were obtained. The results are shown in Table-1.

### Comparative Example 2

0.05 parts by mass of the compound represented by Formula (9) as a photochromic compound and 0.70 parts by mass of dimethyltin dichloride were added to 59.4 parts by mass of dicyclohexylmethane-4,4′-diisocyanate in the same manner as in Example 1, and the resultant product was mixed and stirred to dissolve the solid thereof. 40.6 parts by mass of 4-mercaptomethyl-1,8-dimercapto-3,6-dithiaoctane was added to this mixed liquid, and the resultant product was mixed to dissolve the solid thereof. When the solution became clear, the liquid was degassed at 5 mmHg for 20 minutes, and this solution was injected into a sheet type mold formed of polyethylene. This was put into a furnace at 20° C. and kept for 8 hours, and the temperature was raised to 120° C. over a period of 12 hours. After the resultant product was heated at 120° C. for 3 hours, the mold was taken out from the furnace, and by removing the mold, a molded product obtained by polymerization was obtained (a disc-shape having a diameter of 45 mm and a thickness of 2.0 mm).

The molded product was colored purple, and when placed under solar light rays, the color became slightly darker. When the photochromic property of the molded product was evaluated, the amount of changes (ΔT % max) in light transmittance before and after coloring at the maximum absorption wavelength (λmax: 575 nm) was 10.0%, and since the absorbance at λmax was not recovered to one half of the absorbance before coloring even when one hour had elapsed after stopping irradiation with light rays, the color fading half-life (F1/2) could not be measurable. On the other hand, in the tension test, results that the tensile strength was 69 kgf and the elongation was 4.1% were obtained. The results are shown in Table-1.

From the results of Examples 1 to 11 and Comparative Example 2, it was found that, in Examples, both the amount of changes in light transmittance before and after coloring and the color fading half-life (F1/2) were more favorable compared to those in Comparative Examples, and the photochromic property was excellent. In addition, results that the color fading half-life (F1/2) of the resin obtained in Comparative Example 1 could not be measured, the resin was brittle, and the physical properties such as strength of the resin was poor, compared to the poly(thio)urethane resins obtained in the examples, were obtained.

TABLE 1

| | | | | | Functional group | | | | | |
|---|---|---|---|---|---|---|---|---|---|---|
| | Component | Component | Component | Component | equivalent ratio | | ΔT % max | F½ | Tension | Elongation |
| | A | B | C | D | B/A | C/A | % | sec | kgf | % |
| Example 1 | a-1 | b-1 | C-1 | Formula (9) | 0.40 | 0.60 | 65.2 | 375 | 32 | 12.6 |
| Example 2 | a-1 | b-1 | C-2 | Formula (9) | 0.36 | 0.64 | 32.5 | 1500 | 38 | 5.9 |
| Example 3 | a-2 | b-2 | C-3 | Formula (9) | 0.16 | 0.84 | 60.6 | 345 | 45 | 7.7 |
| Example 4 | a-2 | b-3 | C-3 | Formula (9) | 0.08 | 0.92 | 65.9 | 210 | 39 | 6.9 |
| Example 5 | a-2 | b-4 | C-3 | Formula (9) | 0.20 | 0.80 | 70.6 | 165 | 34 | 7.8 |
| Example 6 | a-3 | b-2 | C-3 | Formula (9) | 0.12 | 0.88 | 49.6 | 1100 | 42 | 8.3 |
| Example 7 | a-3 | b-4 | C-3 | Formula (9) | 0.12 | 0.88 | 75.5 | 115 | 41 | 8.4 |
| Example 8 | a-4 | b-4 | C-3 | Formula (9) | 0.12 | 0.88 | 71.8 | 135 | 50 | 6.7 |
| Example 9 | a-4 | b-5 | C-2 | Formula (9) | 0.16 | 0.84 | 57.1 | 190 | 58 | 6.9 |
| Example 10 | a-4 | b-6 | C-3 | Formula (9) | 0.20 | 0.80 | 55.1 | 1100 | 59 | 7.4 |
| Example 11 | a-4 | b-7 | C-3 | Formula (9) | 0.06 | 0.94 | 61.9 | 145 | 56 | 7.0 |
| Comparative | Methacrylic resin | | | Formula (9) | — | — | 75.4 | 255 | 14 | 0.9 |
| Example 1 | | | | | | | | | | |
| Comparative | a-2 | — | C-3 | Formula (9) | — | 1.00 | 10.0 | Unmeasurable | 69 | 4.1 |
| Example 2 | | | | | | | | | | |

The respective components described in Table-1 are as follows.
(Component A)
a-1: 1,3-bis(isocyanatomethyl) cyclohexane
a-2: dicyclohexylmethane-4,4′-diisocyanate
a-3: m-xylylene diisocyanate
a-4: a mixture of 2,5-bis(isocyanatomethyl)bicyclo[2.2.1] heptane and 2,6-bis(isocyanatomethyl)bicyclo[2.2.1] heptane
(Component B)
b-1: polyethylene glycol having a number average molecular weight of 400
b-2: polyethylene glycol having a number average molecular weight of 1000
b-3: polyethylene glycol having a number average molecular weight of 2000
b-4: polypropylene glycol having a number average molecular weight of 1000
b-5: polypropylene glycol having a number average molecular weight of 700
b-6: polypropylene glycol adduct of 2,2-bis(4-hydroxyphenyl) propane (also referred to as bisphenol A) having a number average molecular weight of 927.
b-7: polyester compound having a number average molecular weight of 2000 obtained by reacting an equimolar mixture of adipic acid and isophthalic acid with 3-methyl-1,5-pentanediol in equimolar ratio
(Component C)
c-1: Glycerin
c-2: pentaerythritol tetrakis(2-mercaptoacetate)
c-3: 4-mercaptomethyl-1,8-dimercapto-3,6-dithiaoctane

From the above, the photochromic optical material of the present invention obtained by polymerizing a polymerizable composition including a di- or higher functional polyisocyanate compound (A), a polyol compound (B) represented by General Formula (1), a di- or higher functional active hydrogen compound (C), and a photochromic compound (D) could impart high photochromic property exceptional in poly(thio)urethane resins in the related art. Accordingly, the photochromic optical material of the present invention is extremely useful as an optical material having photochromic property, used in lenses for spectacles.

In addition, according to the production method of the present invention, it is possible to obtain a photochromic lens by preparing a polymerizable composition by dissolving the photochromic compound (D) in a monomer mixture including the di- or higher functional polyisocyanate compound (A), the polyol compound (B) represented by General Formula (1), the di- or higher functional active hydrogen compound (C) in advance, by injecting the composition into a mold, and by polymerizing the composition. That is, since photochromic property is imparted with lens molding at the same time, it is not necessary to additionally provide a coating layer for imparting photochromic property, and as a result, the number of steps in the production is small. Therefore, the production method of the present invention improves the production efficiency, and is advantage in terms of production cost. Furthermore, since the photochromic compound can be easily homogeneously dispersed into a lens substrate obtained by curing the polymerizable composition, it is extremely useful as a method of mass-producing a lens with stable quality having constant photochromic property regardless of the lens shape.

This application claims priority from Japanese Patent Application No. 2014-018928 filed on February 03, 2014, the content of which is incorporated herein by reference in its entirety.

The present invention also includes the following aspects.

[a1] A polymerizable composition for optical materials including (A) at least one kind of di- or higher functional polyisocyanate compounds, (B) at least one kind of compounds selected from compounds represented by General Formula (I) or (III), (C) at least one kind of di- or higher functional active hydrogen compounds (here, the compound (B) is excluded), and (D) a photochromic compound,

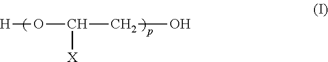

wherein, in Formula (I), p represents a numerical value of 4 to 100, X represents a hydrogen atom or a methyl group, and a plurality of X's may be the same as or different from each other,

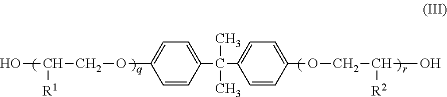

wherein, in Formula (III), each of q and r represents a numerical value of 1 or more, and the sum of q and r represents a numerical value of 2 to 100; and R¹ and R² may be the same as or different from each other, each of R¹ and R² represents a hydrogen atom or a methyl group, and a plurality of R¹'s or R²'s may be the same as or different from each other.

[a2] The polymerizable composition for optical materials according to [a1], in which the active hydrogen compound (C) is at least one kind selected from the group consisting of polyol compounds, polythiol compounds, and thiol compounds having a hydroxy group.

[a3] The polymerizable composition for optical materials according to [a1] or [a2], in which the active hydrogen compound (C) is a tri- or higher functional active hydrogen compound.

[a4] The polymerizable composition for optical materials according to any one of [a1] to [a3], in which the active hydrogen compound (C) is at least one kind selected from the group consisting of glycerin, pentaerythritol tetrakis(2-mercaptoacetate), pentaerythritol tetrakis(3-mercaptopropionate), 4-mercaptomethyl-1,8-dimercapto-3,6-dithiaoctane, 5, 7-dimercaptomethyl-1, 11-dimercapto-3, 6,9-trithiaundecane, 4, 7-dimercaptomethyl-1, 11-dimercapto-3, 6, 9-trithiaundecane, 4, 8-dimercaptomethyl-1, 11-dimercapto-3, 6,9-trithiaundecane, 1,1,3,3-tetrakis(mercaptomethylthio) propane, and trimethylolpropane tris(3-mercaptopropionate).

[a5] The polymerizable composition for optical materials according to any one of [a1] to [a4], in which the compound (B) is a compound represented by General Formula (I).

[a6] The polymerizable composition for optical materials according to any one of [a1] to [a5], in which the compound represented by General Formula (I) is polyethylene glycol or polypropylene glycol.

[a7] The polymerizable composition for optical materials according to any one of [a1] to [a6], in which the number average molecular weight of the compound represented by General Formula (I) is 200 to 4000.

[a8] The polymerizable composition for optical materials according to any one of [a1] to [a7], in which the number average molecular weight of the compound represented by General Formula (I) is 1000 to 3000.

[a9] The polymerizable composition for optical materials according to any one of [a1] to [a8], in which the photochromic compound (D) is represented by the following General Formula (5),

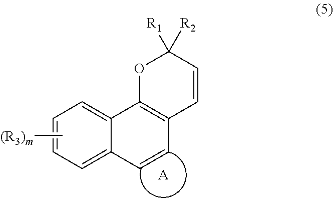

wherein in the formula, R₁ and R₂ may be identical or different, and independently represent

a hydrogen atom;

a linear or branched alkyl group having 1 to 12 carbon atoms;

a cycloalkyl group having 3 to 12 carbon atoms;

a substituted or unsubstituted aryl group having 6 to 24 carbon atoms or a substituted or unsubstituted heteroaryl group having 4 to 24 carbon atoms in which these substituted groups , as a substituent, include at least one substituent selected from a halogen atom, a hydroxyl group, a linear or branched alkyl group having 1 to 12 carbon atoms, a linear or branched alkoxy group having 1 to 12 carbon atoms, a linear or branched haloalkyl group having 1 to 12 carbon atoms that is substituted by at least one halogen atom, a linear or branched haloalkoxy group having 1 to 12 carbon atoms that is substituted by at least one halogen atom, a phenoxy group or naphthoxy group substituted by at least one linear or branched alkyl group or alkoxy group having 1 to 12 carbon atoms, a linear or branched alkenyl group having 2 to 12 carbon atoms, a —NH₂ group, a —NHR group, a —N(R)₂ group in which R represents a linear or branched alkyl group having 1 to 6 carbon atoms, in which in a case that two Rs are present, the two Rs may be identical or different, a methacryloyl group and an acryloyl group; or
an aralkyl or heteroaralkyl group that a linear or branched alkyl group having 1 to 4 carbon atoms is substituted by the aryl group or the heteroaryl group,

R₃ may be identical or different, and independently represent

a halogen atom;

a linear or branched alkyl group having 1 to 12 carbon atoms;

a cycloalkyl group having 3 to 12 carbon atoms;

a linear or branched alkoxy group having 1 to 12 carbon atoms;

a linear or branched haloalkyl group having 1 to 12 carbon atoms that is substituted by at least one halogen atom, a halocycloalkyl group having 3 to 12 carbon atoms that is substituted by at least one halogen atom, a linear or branched haloalkoxy group having 1 to 12 carbon atoms that is substituted by at least one halogen atom;

a substituted or unsubstituted aryl group having 6 to 24 carbon atoms or a substituted or unsubstituted heteroaryl group having 4 to 24 carbon atoms in which these substituted groups , as a substituent, include at least one substituent selected from a halogen atom, a hydroxyl group, a linear or branched alkyl group having 1 to 12 carbon atoms, a linear or branched alkoxy group having 1 to 12 carbon atoms, a linear or branched haloalkyl group having 1 to 12 carbon atoms that is substituted by at least one halogen atom, a linear or branched haloalkoxy group having 1 to 12 carbon atoms that is substituted by at least one halogen atom, a phenoxy group or naphthoxy group substituted by at least one linear or branched alkyl group or alkoxy group having 1 to 12 carbon atoms, a linear or branched alkenyl group having 2 to 12 carbon atoms, and an amino group;

an aralkyl or heteroaralkyl group that a linear or branched alkyl group having 1 to 4 carbon atoms is substituted by the aryl group or heteroaryl group;

a substituted or unsubstituted phenoxy group or naphthoxy group, in which these substituted groups, as a substituent, include at least one substituent selected from a linear or branched alkyl group or alkoxy group having 1 to 6 carbon atoms;

—NH₂, —NHR, —CONH₂, or —CONHR in which R represents a linear or branched alkyl group having 1 to 6 carbon atoms; or

—OCOR₈ or —COOR_{S} in which R₈ represents a linear or branched alkyl group having 1 to 6 carbon atoms, a cycloalkyl group having 3 to 6 carbon atoms, or a phenyl group substituted by at least one substituents of the substituted aryl and the substituted heteroaryl group of R₁ or R₂, or an unsubstituted phenyl group;

m is an integer of 0 to 4;

A represents an annelated ring represented by the following Formula (A₂) or (A₄), and

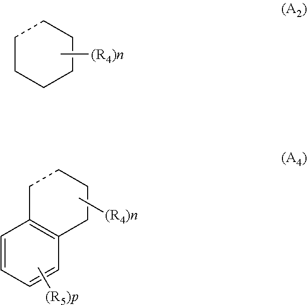

wherein, in these annelated rings,

the dotted lines represent a chemical bond between a carbon C₅ and a carbon C₆ in a naphthopyran ring of a formula (5); an α bond in the annelated ring (A4) can be bonded with the carbon C₅ or the carbon C₆ in the naphthopyran ring of Formula (5);

R₄ is identical or different, and independently represents OH, a linear or branched alkyl group or alkoxy group having 1 to 6 carbon atoms; two R₄s form carbonyl (CO);

R₅ represents halogen atom;

a linear or branched alkyl group having 1 to 12 carbon atoms;

a linear or branched haloalkyl group having 1 to 6 carbon atoms that is substituted by at least one halogen atom;

a cycloalkyl group having 3 to 12 carbon atoms;

a linear or branched alkoxy group having 1 to 6 carbon atoms;

a substituted or unsubstituted phenyl or benzyl group in which these substituted groups include at least one substituents described in the definition of the R₁ and R₂ groups as a substituent in a case that R₁ and R₂ in Formula (5) independently correspond to an aryl or heteroaryl group;

—NH₂ or —NHR in which R represents a linear or branched alkyl group having 1 to 6 carbon atoms;

a substituted or unsubstituted phenoxy group or naphthoxy group in which these substituted groups, as a substituent, include at least one substituent selected from a linear or branched alkyl group or alkoxy group having 1 to 6 carbon atoms; or

a —COR₉, —COOR_{S}, or —CONHR₉ group in which R₉ represents a linear or branched alkyl group having 1 to 6 carbon atoms, a cycloalkyl group having 3 to 6 carbon atoms, or a substituted or unsubstituted phenyl or benzyl group in which these substituted groups include at least one substituents described in the definition of the R₁ and R₂ groups as a substituent in a case that R₁ and R₂ in Formula (5) independently correspond to an aryl or heteroaryl group,

in a case in which A represents (A₄), n is an integer of 0 to 2, p is an integer of 0 to 4, and in a case in which A represents (A2), n is an integer of 0 to 2.

[a10] The polymerizable composition for optical materials according to any one of [a1] to [a9], in which the polyisocyanate compound (A) is at least one kind selected from the group consisting of xylylene diisocyanate, bis(isocyanatomethyl) cyclohexane, and dicyclohexylmethane diisocyanate.

[a11] A molded product comprised of a cured product of the polymerizable composition for optical materials according to any one of [a1] to [a10].

[a12] An optical material comprised of the molded product according to [a11].

[a13] A plastic lens comprised of the molded product according to [a11].

[a14] A process for producing a plastic lens, including a step of preparing a polymerizable composition for optical materials by mixing (A) at least one kind of di- or higher functional polyisocyanate compounds, (B) at least one kind of compounds selected from compounds represented by General Formula (I) or (III), (C) at least one kind of di- or higher functional active hydrogen compounds (here, the compound (B) is excluded), and (D) a photochromic compound, and a step of forming a lens substrate by cast-polymerizing the polymerizable composition for optical materials in a mold,

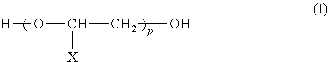

wherein, in Formula (I), p represents a numerical value of 4 to 100, X represents a hydrogen atom or a methyl group, and a plurality of X's may be the same as or different from each other,

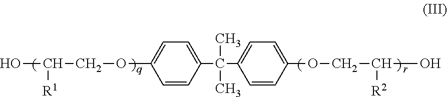

wherein, in Formula (III), q and r may be the same as or different from each other, each of q and r represents a numerical value of 1 or more, and the sum of q and r represents a numerical value of 2 to 100; and R¹ and R² may be the same as or different from each other, each of R¹ and R² represents a hydrogen atom or a methyl group, and a plurality of R¹'s or R²'s may be the same as or different from each other.

1. A polymerizable composition for optical materials, comprising:
a polyisocyanate compound (A),
a polyol compound (B) represented by the following General Formula (1) having a number average molecular weight of 100 or more,
a di- or higher functional active hydrogen compound (C) in which the compound (B) is excluded and
a photochromic compound (D), 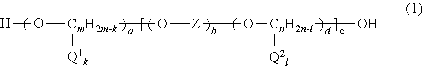
wherein, in Formula (1), m represents a numerical value of 1 to 20, k represents 0 to 2m, n represents a numerical value of 1 to 20, I represents 0 to 2n, a represents a numerical value of 0 or more, b represents a numerical value of 0 or more, d represents a numerical value of 0 or more, and e represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and Z represents a divalent organic group having 1 to 30 carbon atoms which optionally include an aromatic group, and a plurality of Z's may be the same as or different from each other.

2. The polymerizable composition for optical materials according to claim 1,
wherein the polyisocyanate compound (A) is at least one kind selected from the group consisting of hexamethylene diisocyanate, pentamethylene diisocyanate, xylylene diisocyanate, isophorone diisocyanate, bis(isocyanatomethyl) cyclohexane, dicyclohexylmethane diisocyanate, 2,5-bis(isocyanatomethyl)bicyclo[2.2.1]-heptane, 2,6-bis(isocyanatomethyl)bicyclo-[2.2.1]-heptane, tolylene diisocyanate, phenylene diisocyanate, and diphenylmethane diisocyanate.

3. The polymerizable composition for optical materials according to claim 1,
wherein the polyol compound (B) is at least one kind selected from compounds which have a number average molecular weight of 100 or more and which are represented by the following General Formulas (I) to (IV), 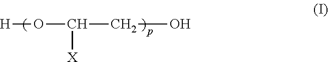
wherein, in Formula (I), p represents a numerical value of 4 to 100, X represents a hydrogen atom or a methyl group, and a plurality of X's may be the same as or different from each other, 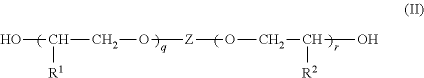
wherein, in Formula (II), q and r may be the same as or different from each other, each of q and r represents a numerical value of 1 or more, and the sum of q and r represents a numerical value of 2 to 100; R¹ and R² may be the same as or different from each other, each of R¹ and R² represents a hydrogen atom or a methyl group, and a plurality of R¹'s or R²'s may be the same as or different from each other; and Z represents a substituted or unsubstituted divalent aromatic group or a divalent aliphatic group which optionally include a substituted or unsubstituted aromatic group having 1 to 20 carbon atoms, 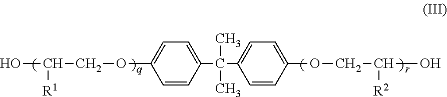
wherein, in Formula (III), q and r may be the same as or different from each other, each of q and r represents a numerical value of 1 or more, and the sum of q and r represents a numerical value of 2 to 100; and R¹ and R² may be the same as or different from each other, each of R¹ and R² represents a hydrogen atom or a methyl group, and a plurality of R¹'s or R²'s may be the same as or different from each other, 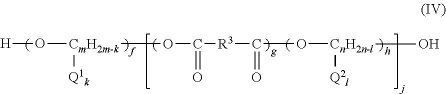
wherein, in Formula (IV), m represents a numerical value of 1 to 20, k represents 0 to 2m, n represents a numerical value of 1 to 20, I represents 0 to 2n, f represents a numerical value of 0 or more, g represents a numerical value of 1 or more, h represents a numerical value of 1 or more, and j represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and R³ represents a linear or branched alkylene group having 1 to 20 carbon atoms or a phenylene group which optionally have a linear or branched alkyl group having 1 to 10 carbon atoms as a substituent, and the plurality of R³'s may be the same as or different from each other.

4. The polymerizable composition for optical materials according to claim 3,
wherein the polyol compound (B) is the compound represented by General Formula (I), (III), or (IV).

5. The polymerizable composition for optical materials according to claim 3,
wherein the compound represented by General Formula (I) is polyethylene glycol or polypropylene glycol.

6. The polymerizable composition for optical materials according to claim 3,
wherein the number average molecular weight of the compound represented by General Formula (I) is 200 to 4000.

7. The polymerizable composition for optical materials according to claim 3,
wherein the number average molecular weight of the compound represented by General Formula (I) is 300 to 3000.

8. The polymerizable composition for optical materials according to claim 3,

13. The polymerizable composition for optical materials according to claim 1,
wherein the active hydrogen compound (C) is at least one kind selected from the group consisting of glycerin, pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, 1,1,3,3-tetrakis(mercaptomethylthio) propane, and trimethylolpropane tris(3-mercaptopropionate).

14. The polymerizable composition for optical materials according to claim 1,
wherein the photochromic compound (D) is represented by the following General Formula (5), 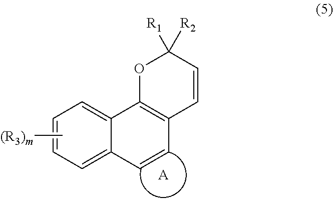
wherein in the formula, R₁ and R₂ may be identical or different, and independently represent
a hydrogen atom;
a linear or branched alkyl group having 1 to 12 carbon atoms;
a cycloalkyl group having 3 to 12 carbon atoms;
wherein the number average molecular weight of the compound represented by General Formula (II) is 400 to 2000.

9. The polymerizable composition for optical materials according to claim 3,
wherein the number average molecular weight of the compound represented by General Formula (Ill) is 400 to 2000.

10. The polymerizable composition for optical materials according to claim 3,
wherein the number average molecular weight of the compound represented by General Formula (IV) is 600 to 3000.

11. The polymerizable composition for optical materials according to claim 1,
wherein the active hydrogen compound (C) is at least one kind selected from the group consisting of polyol compounds, polythiol compounds, and thiol compounds having a hydroxy group.

12. The polymerizable composition for optical materials according to claim 1,
wherein the active hydrogen compound (C) is a tri- or higher functional active hydrogen compound.
a substituted or unsubstituted aryl group having 6 to 24 carbon atoms or a substituted or unsubstituted heteroaryl group having 4 to 24 carbon atoms in which these substituted groups, as a substituent, include at least one substituent selected from a halogen atom, a hydroxyl group, a linear or branched alkyl group having 1 to 12 carbon atoms, a linear or branched alkoxy group having 1 to 12 carbon atoms, a linear or branched haloalkyl group having 1 to 12 carbon atoms that is substituted by at least one halogen atom, a linear or branched haloalkoxy group having 1 to 12 carbon atoms that is substituted by at least one halogen atom, a phenoxy group or naphthoxy group substituted by at least one linear or branched alkyl group or alkoxy group having 1 to 12 carbon atoms, a linear or branched alkenyl group having 2 to 12 carbon atoms, a —NH₂ group, a —NHR group, a —N(R)₂ group in which R represents a linear or branched alkyl group having 1 to 6 carbon atoms, in which in a case that two Rs are present, the two Rs may be identical or different, a methacryloyl group and an acryloyl group; or
an aralkyl or heteroaralkyl group that a linear or branched alkyl group having 1 to 4 carbon atoms is substituted by the aryl group or the heteroaryl group,
R₃ may be identical or different, and independently represent
a halogen atom;
a linear or branched alkyl group having 1 to 12 carbon atoms;
a cycloalkyl group having 3 to 12 carbon atoms;
a linear or branched alkoxy group having 1 to 12 carbon atoms;
a linear or branched haloalkyl group having 1 to 12 carbon atoms that is substituted by at least one halogen atom, a halocycloalkyl group having 3 to 12 carbon atoms that is substituted by at least one halogen atom, a linear or branched haloalkoxy group having 1 to 12 carbon atoms that is substituted by at least one halogen atom;
a substituted or unsubstituted aryl group having 6 to 24 carbon atoms or a substituted or unsubstituted heteroaryl group having 4 to 24 carbon atoms in which these substituted groups, as a substituent, include at least one substituent selected from a halogen atom, a hydroxyl group, a linear or branched alkyl group having 1 to 12 carbon atoms, a linear or branched alkoxy group having 1 to 12 carbon atoms, a linear or branched haloalkyl group having 1 to 12 carbon atoms that is substituted by at least one halogen atom, a linear or branched haloalkoxy group having 1 to 12 carbon atoms that is substituted by at least one halogen atom, a phenoxy group or naphthoxy group substituted by at least one linear or branched alkyl group or alkoxy group having 1 to 12 carbon atoms, a linear or branched alkenyl group having 2 to 12 carbon atoms, and an amino group;
an aralkyl or heteroaralkyl group that a linear or branched alkyl group having 1 to 4 carbon atoms is substituted by the aryl group or heteroaryl group;
a substituted or unsubstituted phenoxy group or naphthoxy group, in which these substituted groups, as a substituent, include at least one substituent selected from a linear or branched alkyl group or alkoxy group having 1 to 6 carbon atoms;
—NH₂, —NHR, —CONH₂, or —CONHR in which R represents a linear or branched alkyl group having 1 to 6 carbon atoms; or
—OCOR₈ or —COOR_{S} in which R₈ represents a linear or branched alkyl group having 1 to 6 carbon atoms, a cycloalkyl group having 3 to 6 carbon atoms, or a phenyl group substituted by at least one substituents of the substituted aryl and the substituted heteroaryl group of R₁ or R₂, or an unsubstituted phenyl group;
m is an integer of 0 to 4;
A represents an annelated ring represented by the following Formula (A₂) or (A₄), and 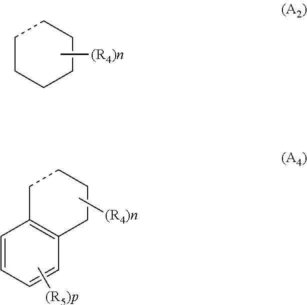
wherein, in these annelated rings,
the dotted lines represent a chemical bond between a carbon C₅ and a carbon C₆ in a naphthopyran ring of a formula (5);
an α bond in the annelated ring (A4) can be bonded with the carbon C₅ or the carbon C₆ in the naphthopyran ring of Formula (5);
R₄ is identical or different, and independently represents OH, a linear or branched alkyl group or alkoxy group having 1 to 6 carbon atoms; two R₄s form carbonyl (CO),
R₅ represents halogen atom;
a linear or branched alkyl group having 1 to 12 carbon atoms;
a linear or branched haloalkyl group having 1 to 6 carbon atoms that is substituted by at least one halogen atom;
a cycloalkyl group having 3 to 12 carbon atoms;
a linear or branched alkoxy group having 1 to 6 carbon atoms;
a substituted or unsubstituted phenyl or benzyl group in which these substituted groups include at least one substituents described in the definition of the R₁ and R₂ groups as a substituent in a case that R₁ and R₂ in Formula (5) independently correspond to an aryl or heteroaryl group;
—NH₂ or —NHR in which R represents a linear or branched alkyl group having 1 to 6 carbon atoms;
a substituted or unsubstituted phenoxy group or naphthoxy group in which these substituted groups, as a substituent, include at least one substituent selected from a linear or branched alkyl group or alkoxy group having 1 to 6 carbon atoms; or
a —COR₉, —COOR_{S}, or —CONHR₉ group in which R₉ represents a linear or branched alkyl group having 1 to 6 carbon atoms, a cycloalkyl group having 3 to 6 carbon atoms, or a substituted or unsubstituted phenyl or benzyl group in which these substituted groups include at least one substituents described in the definition of the Rᵢ and R₂ groups as a substituent in a case that R₁ and R₂ in Formula (5) independently correspond to an aryl or heteroaryl group,
in a case in which A represents (A₄), n is an integer of 0 to 2, p is an integer of 0 to 4, and in a case in which A represents (A₂), n is an integer of 0 to 2.

15. The polymerizable composition for optical materials according to claim 1,
wherein the functional group equivalent ratio (B/A) of the polyol compound (B) to the polyisocyanate compound (A) is 0.02 to 0.6, and the functional group equivalent ratio (C/A) of the active hydrogen compound (C) to the polyisocyanate compound (A) is 0.4 to 0.98.

16. A molded product comprised of a cured product of the polymerizable composition for optical materials according to claim 1.

17. An optical material comprised of the molded product according to claim 16.

18. A plastic lens comprised of the molded product according to claim 16.

19. A process for producing a plastic lens, comprising:
a step of preparing a polymerizable composition for optical materials by mixing a polyisocyanate compound (A), a polyol compound (B) represented by the following General Formula (1) having a number average molecular weight of 100 or more, a di- or higher functional active hydrogen compound (C) in which the compound (B) is excluded, and a photochromic compound (D) and
a step of forming a lens substrate by cast-polymerizing the polymerizable composition for optical materials in a mold, 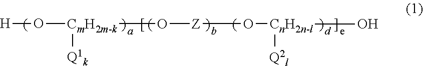
wherein, in Formula (1), m represents a numerical value of 1 to 20, k represents 0 to 2m, n represents a numerical value of 1 to 20, I represents 0 to 2n, a represents a numerical value of 0 or more, b represents a numerical value of 0 or more, d represents a numerical value of 0 or more, and e represents a numerical value of 1 or more; Q¹ represents a hydrogen atom or an alkyl group having 1 to 6 carbon atoms, and a plurality of Q¹'s may be the same as or different from each other; Q² represents a hydrogen atom or an alkyl group having 1 to 6 carbon atoms, and a plurality of Q²'s may be the same as or different from each other; and Z represents a divalent organic group having 1 to 30 carbon atoms which optionally include an aromatic group, and a plurality of Z's may be the same as or different from each other.
